(19) United States
(12) Patent Application Publication
(10) Pub. No.: US 2004/0091810 A1
(43) Pub. Date: May 13, 2004

(54) Microcapsule, and heat-sensitive recording material and multicolor heat-sensitive recording material using the same

(75) Inventors: Masatoshi Yumoto, Shizuoka-ken (JP); Takashi Tamura, Shizuoka-ken (JP); Koreshige Ito, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/693,936

(22) Filed: Oct. 28, 2003

(30) Foreign Application Priority Data
Oct. 31, 2002 (JP) 2002-318140
May 20, 2003 (JP) 2003-141547

(51) Int. Cl. G03C 1/72; G03C 1/54; G03C 1/58

(52) U.S. Cl. 430/138; 430/156; 430/157; 430/176; 503/215

(57) ABSTRACT

The present invention relates to a microcapsule produced by using at least an isocyanate compound, a heat-sensitive recording material including the microcapsules and a multicolor heat-sensitive recording material including the microcapsules, wherein the isocyanate compound is a reaction product of an isocyanate compound with a polyether derivative.

### CROSS-REFERENCE TO RELATED APPLICATION

This application claims priority under 35 USC 119 from Japanese patent Application Nos. 2002-318140 and 2003-141547, the disclosures of which are incorporated by reference herein.

### BACKGROUND OF THE INVENTION

1. Field of the Invention

The present invention relates to a microcapsule that can be used in a heat-sensitive recording material, and a heat-sensitive recording material and a multicolor heat-sensitive recording material using the microcapsule.

2. Description of the Related Art

Heat-sensitive recording materials that have been widely employed as recording media for facsimiles, printers and the like mainly use materials produced by coating a solid dispersion of an electron-donating dye precursor on a support to dry the wet coating. A recording method employing an electron-donating dye precursor is advantageous since raw materials thereof are easy to produce and the method provides high color density and color developing speed. However, color easily develops during storage after recording in a recorded medium due to unintentional heating, attachment of a solvent or the like, and storage conditions. Problems in the recording method with respect to preservability and reliability of a recorded image have led to studies on numerous improvements.

A method to improve preservability of a recorded image has been proposed, in which an electron-donating dye precursor is encapsulated in microcapsules to separate a color developing agent and the dye precursor from each other in a recording layer. This method can realize high color developability and image stability.

Apart from the above, another example of a heat-sensitive recording material that has been studied is a so-called diazo type heat-sensitive recording material which employs a diazo compound. The diazo compound reacts with a phenolic derivative, or with a compound having an active methylene group or the like (a coupler) to form a dye, while at the same time, has photosensitive properties and loses activity under irradiation. Recently, such properties of the diazo compound have also been applied to heat-sensitive recording materials. Proposals have been made on a light fixing heat-sensitive recording material in which a diazo compound and a coupler are caused to react with each other by heating to yield an image, and thereafter the image can be fixed by irradiation (refer to, for example, Koji Sato et al., Journal of Image Electronics Society, Vol. 11, No. 4, 1982, pp.290 to 296).

However, a recording material using a diazo compound has a problem in that because of its high chemical activity, even under low temperature, the diazo compound and a coupler gradually react with each other, resulting in short shelf life. As a solution, a method has been proposed in which the diazo compound is encapsulated in a microcapsule to thereby isolate the diazo compound from a coupler, water and a basic compound (refer to, for example, Tomomasa Usami et al., Journal of Electrophotographic Society, Vol. 26, No. 2, 1987, pp.115 to 125).

Attention has been drawn to a multicolor heat-sensitive recording material as an application field of a heat-sensitive material. While reproduction of a multicolor image by heat-sensitive recording has been regarded as difficult, as compared with an electrophotographic recording method or an ink jet method, it has been found that a multicolor heat-sensitive recording material can be obtained by stacking two or more heat-sensitive recording layers each including an electron-donating dye precursor and a color developing agent, combined as main components on a support, or by stacking two or more heat-sensitive recording layers each including a diazo compound and a coupler that reacts with the diazo compound during heating to develop color on a support. As for multicolor recording material, it is indispensable that a thermal color developability of microcapsules be highly controlled in order to obtain excellent color reproducibility.

In order to put an electron-donating dye precursor or a diazo compound in a microcapsule, generally, the compounds are dissolved into an organic solvent (an oil phase) and the solution is then emulsion dispersed in an aqueous solution (a water phase) of a water-soluble polymer. During this procedure, a monomer or a prepolymer forming a wall material is added into the organic solvent phase or the water phase to thereby form a polymer wall at the interface between the organic solvent phase and the water phase. This enables encapsulation of the compounds in microcapsules (refer to, for example, Tomoshi Kondo, in “Microcapsule”: The Nikkan Kogyo Shimbun, Ltd., 1970 and Tamotu Kondo, in “Microcapsule”: Sankyo Shuppan, 1977). Various materials can be used for the microcapsule wall such as gelatin, an alginate, celluloses, polyurea, polyurethane, melamin resin, nylon. Among the examples, polyurea and urethane resin are preferable in designing a heat-sensitive recording material since glass transition temperatures of the materials range from room temperature to about 200° C., thus indicating heat responsiveness.

In a case of microcapsules each having a polyurethane or polyurea wall, the following production process has been known: A diazonium salt or an electron-donating dye precursor is first dissolved into an organic solvent, then a polyvalent isocyanate compound is added into the organic solution, followed by emulsification of the second organic solution in an aqueous solution of water-soluble polymer. Thereafter, a catalyst for acceleration of a polymerization reaction is added, or temperature of the emulsion is raised to polymerize the polyvalent isocyanate compound with a compound having an active hydrogen such as water to form capsule walls.

Examples of polyvalent isocyanate compounds that are materials forming the polyurea or polyurethane wall described above, which have been mainly used, include: an adduct of 2,4-tolylene diisocyanate with trimethylolpropane, and an adduct of xylylene diisocyanate with trimethylolpropane (refer to, for example, Japanese Patent Application Laid-Open (JP-A) Nos. 62-212190 and 4-261893).

However, even though capsule walls made from polyurea or polyurethane using a polyvalent isocyanate compound as described above has been adopted, sufficient improvements have not been made in addressing the issue of short shelf life as described in the above case where a diazo compound is used. That is, a heat-sensitive recording material having insufficient shelf life causes color development of the background portion, which is called “fog,” if the recording material is exposed to an atmosphere under conditions of high temperature and high humidity before actual use in recording after producing, which degrades visibility of a printed image. Such a problem can be solved by resorting to increasing the wall thickness of microcapsules. However, such a measure causes reduced color developing sensitivity during thermal printing. Therefore, it has been very difficult to further improve the shelf life while maintaining high color developability.

In order to solve such a problem, a method has been known in which part of a polyvalent isocyanate compound is caused to react with a monoalcohol compond in advance, and thereafter the polyvalent isocyanate is reacted in a regular process (refer to, for example, JP-A No. 5-317694). However, a monoalcohol used as a specific example in this case is a compound having 2 to 9 carbon atoms in a molecule, and when the reaction ratio of the monoalcohol is increased, sensitivity improves but fog increases. Contrarily, decreasing the reaction ratio of the monoalcohol can prevent fog, but the effect of improved sensitivity will be insufficient.

In the multicolor heat-sensitive heat recording material described above, heat-sensitive layers are provided in cyan, magenta and yellow, respectively, which are printed at respective different heating temperatures as process parameters, requiring further enhanced heat responsiveness, as compared with a case of a heat-sensitive recording layer made of ordinary heat-sensitive recording material. The above conventional capsule walls of polyurea or polyurethane do not sufficiently satisfy such a requirement.

In order to raise thermal sensitivity, a heat sensitizer can be added into the heat-sensitive recording layer in a heat-sensitive recording material. P-toluenesulfonamide or the like has been known as a heat sensitizer with excellent performance (refer to, for example, Japanese Patent Application Publication (JP-B) No. 6-55546). Another example showing further distinguished performance is an arylsulfonamide compound having a specific substituent in a molecule (refer to, for example, JP-A No. 9-39389). In order to reduce haze in the heat-sensitive recording layer in a multicolor heat-sensitive recording material, it is necessary to emulsify the arylsulfonamide described above. No specific limitation is imposed on a particular process for the emulsification- any conventionally known method can be employed. Specifically, an arylsulfonamide compound described above is dissolved into an organic solvent hardly soluble or insoluble in water, and the solution is mixed into a water phase containing a surfactant and/or a water-soluble polymer as a protective colloid, while the mixture is agitated, to form an emulsified dispersion (refer to, for example, JP-A No. 2-141279).

Since such a heat sensitizer, however, is usually a crystalline material, there are cases where problems occur in that an emulsion containing such a sensitizer generates precipitation of crystals after a prolonged period. Therefore, there has been a desire for development of microcapsules having sufficient thermal sensitivity without using a heat sensitizer, or if used, with a small amount thereof.

In light of such a problem, a heat-responsive microcapsule has been disclosed that is made of a polymer obtained by polymerization of an isocyanate compound containing an adduct of (A) a compound having at least one kind selected from the group consisting of a polyether chain, a polyester chain, and a polysiloxane chain, each having at least two active hydrogen atoms in a molecule, and an average molecular weight in the range of 500 to 20,000 with (B) a polyvalent isocyanate having two or more isocyanate groups in a molecule (refer to, for example, JP-A No. 11-550). Herein, as a compound having at least one kind selected from the group consisting of a polyether chain, a polyester chain and a polysiloxane chain, each having at least two active hydrogen atoms in a molecule, and an average molecular weight in the range of 500 to 20,000, there has been disclosed only a polymer having active hydrogen atoms at both terminals of its chain. In the disclosure of the reference, no description is found regarding an effect wherein there is used a polyether derivative having two or more functional groups each including active hydrogen atoms at one terminal, and further having a degree of polymerization of a polyether moiety thereof in the range of 10 to 500, which is desclosed in present invention.

A heat-responsive microcapsule has been disclosed that is made of a polymer obtained by polymerization of an isocyanate compound including an adduct of at least one kind of (A) a compound having one hydrogen atom in a molecule, and an average molecular weight in the range of 500 to 20,000 and (B) a polyfunctional isocyanate having two or more isocyanate groups in a molecule, and in the microcapsule, fog and sensitivity are compatible with each other (refer to, for example, JP-A No. 10-114153). Herein, in respect of compounds each having one active hydrogen atom in a molecule and having an average molecular weight in the range of 500 to 20,000, a hydroxyl group and an amino group as functional groups each having one active hydrogen atom; and a polyether derivative having an average molecular weight in the range of 500 to 20,000 are separately described in the specification. In an example thereof, there is described only a polyether derivative having a hydroxyl group as a functional group having an active hydrogen atom. Furthermore, in the description of the example, it is found that in a reaction of a polyether derivative having a hydroxyl group as a functional group having an active hydrogen atom with a polyfunctional isocyanate, stannous octilate is added to the reaction mixture in order to increase activity of the reaction, which raises concerns about toxicity associated with remains of the tin compound in the system. Therefore, there has been a desire for a polyether derivative having an active hydrogen atom reacting with a polyfunctional isocyanate without addition of a tin compound.

A microcapsule having a polyurea crust has been disclosed in which an isocyanate used in producing is a reaction product between at least a bifunctional isocyanate and a monovalent polyethylene oxide alcohol (refer to, for example, Japanese Patent No. 3266330). In this case, a temperature as high as 110° C. is adopted during synthesis of the reaction product, which is problematic in terms of energy efficiency. Moreover, in the specification, no description is altogether found regarding a polyether derivative having an amino group at a terminal in a molecule.

### SUMMARY OF THE INVENTION

It is an object of the present invention to provide a microcapsule that can be preferably used in a heat-sensitive recording material and a multicolor heat-sensitive recording material. Another object of the invention is to provide a microcapsule using an isocyanate compound that can be synthesized with good energy efficiency while imposing minimal environmental burden.

Yet another object of the invention is to provide a microcapsule that can be preferably used in a heat-sensitive recording material and a multicolor heat-sensitive recording material, showing high color developability by contact with a coupler or a color developing agent, and excellent in raw preservability (shelf life).

Yet another object of the invention is to provide a heat-sensitive recording material having high sensitivity, high color developing property, and excellent raw preservability (long shelf life). Still another object of the invention is to provide a multicolor heat-sensitivity recording material having high sensitivity, excellent color reproducibility, and excellent raw preservability.

The inventors has conducted an intensive study on an isocyanate used in capsule formation from the viewpoint of further improving shelf life of a heat-sensitive recording material while maintaining high color developing property, and from the viewpoint of synthesis of the isocyanate with a minimum environmental burden and with a good energy efficiency, and the inventors have achieved the invention.

That is,

A first aspect of the invention is to provide a microcapsule (P) produced using at least an isocyanate compound, wherein the isocyanate compound is a reaction product of (A) a compound having at least two isocyanate groups in a molecule with (B) a polyether derivative having two or more functional groups each having an active hydrogen atom at one terminal thereof and a polyether moiety that has a degree of polymerization in the range of 10 to 500.

A second aspect of the invention is to provide a microcapsule (Q) produced using at least an isocyanate compound, wherein the isocyanate compound is a reaction product of (A) a compound having at least two isocyanate groups in a molecule with (B) a polyether derivative having two or more functional groups each having an active hydrogen atom at one terminal thereof and a polyether moiety that has a degree of polymerization in the range of 10 to 500, wherein the polyether derivative is represented by the following general formula (1):

R—O—(L-O)_{N}—X-A-(NH₂) General formula (1)

wherein X represents a single bond, —CO— or —SO₂—; A represents an arenetriyl or arenetetrayl group, or an alkanetriyl or alkanetetrayl group based on the selection of m selected from 2 or 3; L represents an alkylene group; R represents an alkyl group, an aryl group, or an acyl group; and n is an integer from 10 to 500.

A third aspect of the invention is to provide the microcapsule (O), wherein A in general formula (1) is an arenetriyl group having two NH₂ groups as substituents and having 6 to 30 carbon atoms in total, or an arenetetrayl group having three NH₂ groups as substituents and having 6 to 30 carbon atoms in total.

A fourth aspect of the invention is to provide the microcapsule (O), wherein A in general formula (1) is an alkanetriyl group having two NH₂ groups as substituents and having 1 to 30 carbon atoms in total, or an alkanetetrayl group having three NH₂ groups as substituents and having 1 to 30 carbon atoms in total.

A fifth aspect of the invention is to provide the microcapsule (P), comprising a diazo compound or an electron-donating dye precursor.

A sixth aspect of the invention is to provide the microcapsule (O), comprising a diazo compound or an electron-donating dye precursor.

A seventh aspect of the invention is to provide a heat-sensitive recording material comprising a heat-sensitive recording layer formed on a support, the heat-sensitive recording layer including a microcapsule containing (i) a coupler and a diazo compound or (ii) a color developing agent and a microcapsule containing an electron-donating dye precursor,

wherein the microcapsule is the microcapsule (P) further containing a diazo compound or an electron-donating dye precursor.

A eighth aspect of the invention is to provide a heat-sensitive recording material comprising a heat-sensitive recording layer formed on a support, the heat-sensitive recording layer including (i) a coupler and a microcapsule containing a diazo compound or (ii) a color developing agent and a microcapsule containing an electron-donating dye precursor,

wherein the microcapsule is the microcapsule (O) further containing a diazo compound or an electron-donating dye precursor.

A ninth aspect of the invention is to provide a multicolor heat-sensitive recording material comprising a heat-sensitive recording layer that develops cyan, a heat-sensitive recording layer that develops magenta and a heat-sensitive recording layer that develops yellow, formed on a support, each of the heat-sensitive recording layers including (i) a coupler and a microcapsule containing a diazo compound; or (ii) a color developing agent and a microcapsule containing an electron-donating dye precursor,

wherein at least one kind of microcapsule is the microcapsule (P) further containing the diazo compoud or the electron-donating dye precursor.

A tenth aspect of the invention is to provide a multicolor heat-sensitive recording material comprising a heat-sensitive recording layer that develops cyan, a heat-sensitive recording layer that develops magenta and a heat-sensitive recording layer that develops yellow, formed on a support, each of the heat-sensitive recording layers including (i) a coupler and a microcapsule containing a diazo compound; or (ii) a color developing agent and a microcapsule containing an electron-donating dye precursor,

wherein at least one kind of microcapsule is the microcapsule (O) further containing the diazo compoud or the electron-donating dye precursor.

An eleventh aspect of the invention is to provide a microcapsule (R) having a polyurea or a polyurethane/urea wall, obtained by polymerization of an isocyanate compound with a compound having an active hydrogen atom, wherein at least one kind of the isocyanate compound is a reaction product of (1) a isocyanate compound having at least two isocyanate groups with (2) a polyether derivative having a terminal amino group represented by the following general formula (1′):

R—O(L-O)ₙ—(X)ₘ-A-NH₂ General formula (1′)

wherein X represents —CO— or —SO₂—; A represents an arylene group, or an alkylene group; L represents an alkylene group; R represents an alkyl group, an aryl group, or an acyl group; m is an integer of 0 or 1; and n is an average additional molar number of a polyether group in the range of 10 to 500.

A twelfth aspect of the invention is to provide the microcapsule (R), wherein in general formula (1′), A represents an arylene group, and m is an integer of 1.

A thirteenth aspect of the invention is to provide the microcapsule (R), wherein in general formula (1′), a group represented by —(X)ₘ-A-NH₂ is selected from the group consisting of an aminoethyl group, an aminopropyl group, a 4-aminobenzoyl group, a 3-aminobenzoyl group, a 4-aminobenzensulfonyl group, an aminoacetyl group, and an aminoethylsulfonyl group.

A fourteenth aspect of the invention is to provide the microcapsule (R), wherein in general formula (1′), a moiety represented by —(L-O)ₙ— is selected from the group consisting of polyethylene oxide, polypropylene oxide, polytetramethylene oxide, polystyrene oxide, polycyclohexylene oxide, a polyethylene oxide-polypropylene oxide-block copolymer, and a polyethylene oxide-polypropylene oxide random copolymer.

A fifteenth aspect of the invention is to provide the microcapsule (R), comprising a diazo compound or an electron-donating dye precursor.

A sixteenth aspect of the invention is to provide the microcapsule (R), further comprising a diazo compound or an electron-donating dye precursor, wherein in general formula (1′), A represents an arylene group, and m is an integer of 1.

A seventeenth aspect of the invention is to provide a heat-sensitive recording material comprising a support and a heat-sensitive recording layer including (1) a microcapsule containing a diazo compound, and a coupler; or (2) a microcapsule containing an electron-donating dye precursor, and a color developing agent; the heat-sensitive recording layer being formed on the support, wherein the microcapsule is the microcapsule (R) further containing a diazo compound or an electron-donating dye precursor.

A eighteenth aspect of the invention is to provide a heat-sensitive recording material comprising a support and a heat-sensitive recording layer including (1) a microcapsule containing a diazo compound, and a coupler; or (2) a microcapsule containing an electron-donating dye precursor, and a color developing agent; the heat-sensitive recording layer being formed on the support, wherein the microcapsule is the microcapsule (R) further containing a diazo compound or an electron-donating dye precursor, and in general formula (1′), A represents an arylene group, and m is an integer of 1.

A nineteenth aspect of the invention is to provide a multicolor heat-sensitive recording material comprising a support and heat-sensitive recording layers in cyan, magenta and yellow, respectively, formed on the support, each of the heat-sensitive recording layers including (1) a microcapsule containing a diazo compound, and a coupler; or (2) a microcapsule containing an electron-donating dye precursor, and a color developing agent,

wherein at least one kind of the microcapsule is the microcapsule (R) further containing a diazo compound or an electron-donating dye precursor.

A twentieth aspect of the invention is to provide a multicolor heat-sensitive recording material comprising a support and heat-sensitive recording layers in cyan, magenta and yellow, respectively, formed on the support, each of the heat-sensitive recording layers including (1) a microcapsule containing a diazo compound, and a coupler; or (2) a microcapsule containing an electron-donating dye precursor, and a color developing agent,

wherein at least one kind of the microcapsule is the microcapsule (R) further containing a diazo compound or an electron-donating dye precursor, and in general formula (1′), A represents an arylene group, and m is an integer of 1.

### DETAILED DESCRIPTION OF THE INVENTION

Detailed description will be given of a microcapsule, a heat-sensitive recording material and a multicolor heat-sensitive recording material according to a first embodiment of the present invention hereinafter.

<Microcapsule>

A microcapsule of the invention is a microcapsule produced by using at least an isocyanate compound wherein the isocyanate compound is a reaction product of (A) a compound having at least two isocyanate groups in a molecule with (B) a polyether derivative, having, at one terminal of a molecule thereof, at least two functional groups each of which include an active hydrogen atom, wherein a polyether moeity of the polyether derivative has a degree of polymerization in the range of from 10 to 500.

Polyether Derivative

A polyether derivative according to the invention has, at one terminal of a molecule thereof, two or more functional groups each containing an active hydrogen atom, and do not have any functional group containing an active hydrogen atom at the other terminal thereof.

Specific examples of the functional group containing an active hydrogen atom include a hydroxyl group, a primary amino group, a secondary amino group, and a carboxyl group. Among them, a hydroxyl group, a primary amino group, and a secondary amino group are preferable. A primary amino group is particularly preferable. The two or more functional groups each having an active hydrogen atom included in the polyether derivative may be the same or different, preferably being the same. The number of functional groups each having an active hydrogen atom included in the polyether derivative is preferably 3 or less from the viewpoint of the sensitivity in a case where a microcapsule of the invention is used in a heat-sensitive recording material.

In the invention, it is a feature thereof that a polymerization degree of a polyether moiety of the polyether derivative is in the range of from 10 to 500. If a polymerization degree of a polyether moiety of the polyether derivative is less than 10, a fog is intensified in a case where a microcapsule of the invention is used in a heat-sensitive recording material. In contrast, if the polymeization degree is more than 500, it is difficult to synthesize the polyether derivative and since a polyether derivative is of a high viscosity, solution preparation in capsule formation and formation of a capsule become difficult.

Specific examples of the polyether moiety include: polyethylene oxide; polypropylene oxide; polytetramethylene oxide; polystyrene oxide; polycyclohexylene oxide; poly(ethylenethioglycol); copolymers thereof; and the like. Each of the compounds and copolymers thereof may include repeating units of one kind or plural kinds.

A polyether moiety described above may have a melting point. In such a case, the melting point is preferably in the range of 40 to 180° C. The term, “a melting point of a polyether moiety” means a melting point of a polyether containing the same repeating units and the same polymerization degree as the polyether moiety. Examples of the polyether moiety having such a melting point include polyethylene oxide and polystyrene oxide. The melting point cannot be specifically defined since it depends on a molecular weight of the polyether moiety. In a case of polyethylene oxide, for example, such a melting point exists in a case where a molecular weight is about 1000 or more.

Among them, polyethylene oxide, polypropylene oxide, polytetramethylene oxide, polystyrene oxide, polycyclohexylene oxide, polyethylene oxide-polypropylene oxide-block copolymer, polyethylene oxide-polypropylene oxide random copolymer, and the like are preferable.

A polyether derivative described above is preferably a compound represented by the following general formula (1).

R—O—(L-O)ₙ—X-A-(NH₂)ₘ General formula (1)

In the general formula (1), X represents a single bond, —CO— or —SO₂—; A represents an an arenetriyl or arenetetrayl group, or an alkanetriyl or alkanetetrayl group based on the selection of m selected from 2 or 3; L represents an alkylene group; R represents an alkyl group, arylene group or an acyl group; and n is an integer of 10 to 500.

Since a polyether derivative represented by the general formula (1) is synthesized with ease, an isocyanate compound and a microcapsule using the polyester derivative as a starting material can be produced with ease. A high sensitivity and a low level of fogging can be compatible in a heat-sensitive recording material using a microcapsule of the invention produced with a polyether derivative represented by the general formula (1) as a starting material.

In the general formula (1), an arenetriyl group represented by A has two NH₂ groups as substituents and may have other additional substituents, and an arenetetrayl group represented by A has three NH₂ groups as substituents and may have other additional substituents. It must be noted that in the present invention, as the number of other such additional substituents may increases, the valence characteristics of A will be altered accordingly. For example, when the number of the substituted NH₂ groups is three and the number of the other such additional substituent becomes one, A will be arenepentayl group when A is aromatic. The arenetriyl group and the arenetetrayl group represented by A preferably have 6 to 30 carbon atoms in total and particularly preferably 6 to 20 carbon atoms in total. With respect to the arenetriyl group and the arenetetrayl group represented by A, examples of -A-(NH₂)ₘ in the general formula (1) include the groups represented by the following formulae.

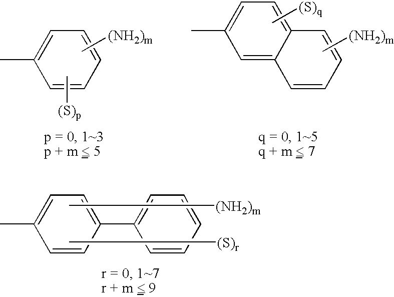

In the formulae, S represents substituents other than an NH₂ group in the arenetriyl or arenetetrayl group expressed by A and preferable examples thereof include a halogen atom, an alkyl group, an alkoxy group, an alkoxycarbonyl group, an aryloxycarbonyl group, and a cyano group. A halogen atom, an alkyl group, and an alkoxy group are particularly preferable.

In the general formula (1), an alkanetriyl group represented by A has two NH₂ groups and may have other substituents than the NH₂ groups, and an alkanetetrayl group represented by A has three NH₂ groups and may have other substituents than the NH₂ groups. It must be noted that in the present invention, as the number of other such additional substituents may increases, the valence characteristics of A will be altered accordingly. For example, when the number of the substituted NH₂ groups is three and the number of the other such additional substituent becomes one, A will be alkanepentayl group when A belongs to alkane series. The alkanetriyl group and the alkanetetrayl group represented by A may be branched and may preferably have 1 to 30 carbon atoms in total and particularly preferably 1 to 20 carbon atoms in total. Examples of substituents on an alkanetriyl or alkanetetrayl group represented by A include an aryl group, an alkenyl group, an alkoxy group, and an alkoxycarbonyl group. Among them, an aryl group is particularly preferable. With respect to the alkanetriyl or alkanetetrayl groups represented by A, groups represented by the following formula may be used as -A-(HN₂)ₘ in the general formula (1).

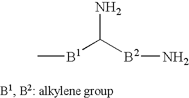

The group represented by A is preferably an arenetriyl group or an arenetetrayl group. In the general formula (1), m is preferably 2.

An alkylene group represented by L in the general formula (1) may have a substituent and may be branched. The alkylene group represented by L may preferably have 2 to 20 carbon atoms in total and particularly preferably 2 to 10 carbon atoms in total. Preferable examples of the substituent include an aryl group, an alkenyl group, an alkoxy group, an acyl group. Among them, an aryl group is particularly preferable. Examples of such an alkylene group include ethylene, propylene, tetramethylene, phenylethylene, cycloxylene, vinylethylene, and phenoxymethylethylene.

The n repeating units each represented by —(L-O)— may represent groups independently, particularly preferably representing the same group. Examples of a polyether moiety containing such repeating units include polyethylene oxide, polypropylene oxide, polytetramethylene oxide, polystyrene oxide, polycyclohexylene oxide, polyethylene oxide-polypropylene oxide-block copolymer, and polyethylene oxide-polypropylene oxide random copolymer.

An alkyl group represented by R in the general formula (1) may have a substituent and may be branched. The alkyl group represented by R may preferably have 1 to 30 carbons in total and particularly preferably 1 to 20 carbons in total. The substituent is preferably an aryl group, an alkenyl group, or an alkoxy group. Examples of the alkyl group include a methyl, an ethyl group, a butyl group, an isopropyl group, a behenyl group, a benzyl group, an allyl group, an oleyl group, and a methoxyethyl group.

An aryl group represented by R in the general formula (1) may have a substituent and may preferably have 6 to 30 carbon atoms in total and particularly preferably 6 to 20 carbon atoms in total. The substituent is preferably a halogen atom, an alkyl group, an alkenyl group, an alkynyl group, or alkoxy group. Among them, an alkyl group and an alkoxy group are particularly preferable. Examples of such an aryl group include a phenyl group, a nonylphenyl group, an octylphenyl group, a fluorophenyl group, a styrylphenyl group, a phenylethenylphenyl group, and a methoxyphenyl group.

An acyl group represented by R in the general formula (1) may be either an aliphatic acyl group or an aromatic acyl group. The acyl group represented by R may have a substituent and may be branched. The acyl group may preferably have 2 to 30 carbon atoms in total and particularly preferably 2 to 20 carbon atoms. The substituent is preferably an alkyl group, and aryl group, an alkenyl group, or an alkoxy group. Examples of such an acyl group include an acetyl group, a benzoyl group, a (meth)acryloyl group, an oleoyl group, a lauroyl group, a stearoyl group, and a methoxybenzoyl group.

R described above is preferably an alkyl group or an acyl group, and particularly preferably an alkyl group.

A polyether derivative represented by the general formula (1) is a compound that may be synthesized through a step of reducing a nitro group to produce an amino group as described later. Therefore, in a case where a polyether derivative represented by the general formula (1) is synthesized through a step of reducing a nitro group to produce an amino group, a nitro group cannot be a substituent on R.

In the general formula (1), n is preferably an integer from 10 to 400 and particularly preferably from 10 to 300.

There are shown specific examples of a polyether derivative according to the invention. However, the invention is not limited to the following specific examples.

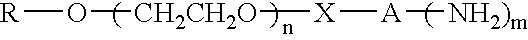

| No | R— | 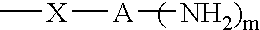 | n |
|---|---|---|---|
| 1-1 | CH₃— | 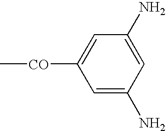 | 98 |
| 1-2 | CH₃— | 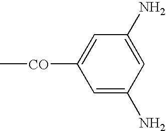 | 110 |
| 1-3 | CH₃— | 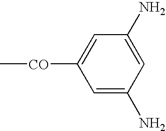 | 90 |
| 1-4 | CH₃— | 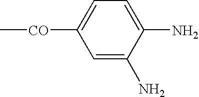 | 98 |
| 1-5 | CH₃— | 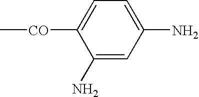 | 45 |
| 1-6 | CH₃— | 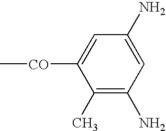 | 45 |
| 1-7 | (n)C₁₂H₂₅— | 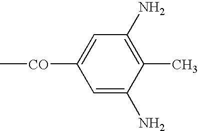 | 17 |
| 1-8 | 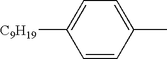 | 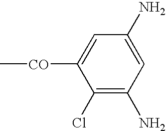 | 113 |
| 1-9 | CH₃— | 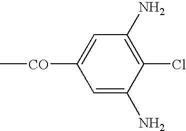 | 98 |
| 1-10 | C₈H₁₇CH═CH—C₇H₁₄CO— | 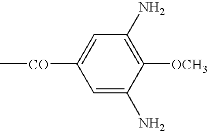 | 45 |
| 1-11 | CH₃— | 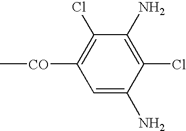 | 98 |
| 1-12 | CH₃— | 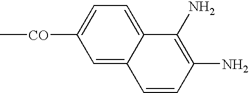 | 90 |
| 1-13 | CH₃— | 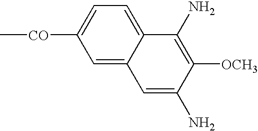 | 98 |
| 1-14 | C₂H₅— | 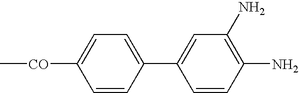 | 75 |
| 1-15 | CH₃— | 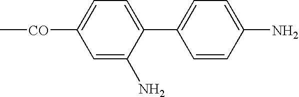 | 45 |
| 1-16 | CH₃— | 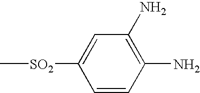 | 98 |
| 1-17 | (n)C₁₁H₂₃CO— | 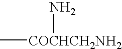 | 45 |
| 1-18 | CH₃— | 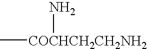 | 98 |
| 1-19 | CH₃— | 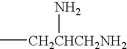 | 20 |
| 1-20 | C₂₂H₄₅— | 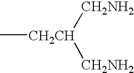 | 300 |
| 1-21 | CH₃— | 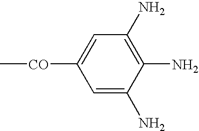 | 98 |

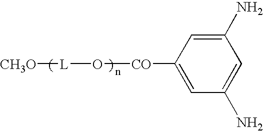

| No | 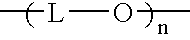 | n |
|---|---|---|
| 2-1 | 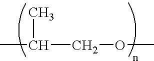 | 90 |
| 2-2 | 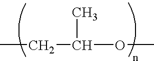 | 45 |
| 2-3 | 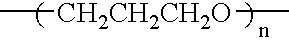 | 70 |
| 2-4 | 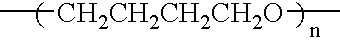 | 20 |
| 2-5 | 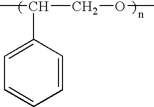 | 30 |
| 2-6 | 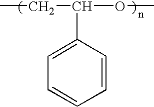 | 100 |
| 2-7 | 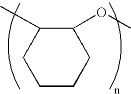 | 18 |
| 2-8 | 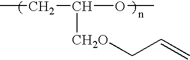 | 25 |
| 2-9 | 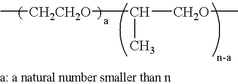 | 100 |

| | |
|---|---|
| 3-1 | 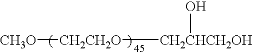 |
| 3-2 | 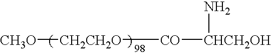 |
| 3-3 | 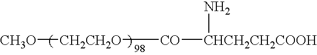 |
| 3-4 | 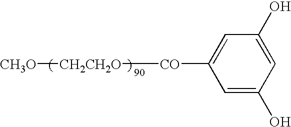 |
| 3-5 | 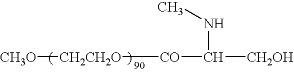 |

A polyether derivative represented by the general formula (1) can be synthesized according to known processes. The following literatures can be referenced for a synthetic process: J. Org. Chem., 45, 5364 (1980), JP-A No. 11-263834, Eur. Poly. J., 19, 341 (1983), J. Am. Chem. Soc., 118, 10150 (1996), Tetrahedron Letters, 43, 1529 (2002) and the like. For example, if A represents an aryl group, a corresponding polyether derivative can be produced in a procedure in which a compound represented by the following general formula (2) is caused to react with an aromatic nitro compound represented by the following general formula (3) to thereby obtain a compound represented by the following general formula (4), followed by hydrogen reduction of the compound represented by the general formula (4) in the presence of a catalyst for catalytic hydrogen reduction.

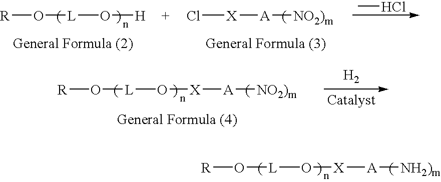

wherein R, L, A, X, n and m respectively have the same definitions as in the general formula (1)

In a reaction of a compound represented by the general formula (2) with a compound represented by the general formula (3), it is preferable to use bases such as triethylamine, pyridine, DBU, sodium hydride. In the reaction, a solvent may be used and preferable examples thereof include toluene, acetonitrile, tetrahydrofuran, and methylene chloride. The temperature of the reaction is preferably a temperature of 0° C. to 100° C. or the reflux temperature of a solvent used in the reaction.

A known catalyst can be used for catalytic hydrogen reduction of a compound represented by the general formula (4) and detailed information thereon is obtained from Japan Chemical Society (Ed.), “Experimental Chemistry Lecture 26,” 4th ed. Tokyo; Maruzen Co., Ltd., 1992; pp.251-266. In the catalytic reduction of a compound represented by the general formula (4), a solvent may be used and preferable examples thereof include methanol, ethanol, 2-propanol, tetrahydrofuran, and chloroform. The temperature of the hydrogen reduction is preferably a temperature of 0° C. to 60° C. or the reflux temperature of a solvent employed in the reaction.

Examples of a compound that has at least two isocyanate groups in a molecule, which is used in the invention include: m-phenylenediisocyanate, p-phenylenediisocyanate, 2,6-tolylenediisocyanate, 2,4-tolylenediisocyanate, naphthalene-1,4-diisocyanate, diphenylmethane-4,4′-diisocyanate, 3,3′-dimethoxy-diphenyldiisocyanate, 3,3′-dimethyldiphenylmethane-4,4′-diisocyanate, xylylene-1,4′-diisocyanate, xylylene-1,3-diisocyanate, 4-chloroxylylene-1,3-diisocyanate, 2-methylxylylene-1,3-diisocyanate, 4,4′-dihenylpropanediisocyanate, 4,4′-diphenylhexafluoropropanediisocyanate, trimethylenediisocyanate, hexamethylenediisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatemethyl)cyclohexane, 1,3-bis(isocyanatemethyl)cyclohexane, isophoronediisocyanate, lysinediisocyanate. Other examples that can be used include adducts of a compound having two isocyanate groups with any of bifunctional alcohols such as ethylene glycols and bisphenols, and adducts of a compound having two isocyanate groups with phenols.

Further, compounds each having three or more isocyanate groups can also be used. Such compounds include trimers (buret compounds or isocyanurates) of the compounds each having two isocyanate groups obtained by using the compounds each having two isocyanate groups as main components; polyfunctional compounds each of which is an adduct of a polyol such as trimethylolpropane with compounds each having two isocyanate groups; formalin condensates of benzeneisocyanates; polymer compounds of isocyanate compounds each having a polymerizable group such as methacryloyloxyethylisocyanate; and a lysinetriisocyanate.

Preferable examples among compounds each having at least two isocianate groups in a molecule include: trimers (buret compounds or isocyanulates) comprising xylylene diisocianate, tolylene diisocyanate, xylene diisocyanate, a hydrogenated compound thereof, hexamethylene diisocianate, tolylene diisocyanate, or a hydrogenated compound thereof as a main monomer; and polyfunctional adducts of trimethylolpropane with compounds each having two isocyanate groups. Information on the compounds are obtained in Keiji Iwata (Ed.), “Polyurethane Resin Hand Book” The Nikkan Kogyo Shimbun, Ltd., 1987.

Among them, 2,4-tolylene diisocyanate, 2,6,-tolylene diisocyanate, xylylene-1,4-diisocyanate, xylylene-1,3-diisocyanate and adducts of trimethylolpropane with xylylene-1,4-diisocyanate or xylylene-1,3-diisocyanate, are more preferable. And xylylene-1,4-diisocyanate, xylylene-1,3-diisocyanate and adducts of trimethylolpropane with xylylene-1,4-diisocyanate or xylylene-1,3-diisocyanate are most preferable.

The Isocyanate compound according to the invention is the reaction product of a compound having at least two isocyanate groups with a polyether derivative described above. A reaction product having a urea group, as a bond, obtained by a reaction of a compound having at least two isocyanate groups with a polyether derivative represented by the general formula (1), is a preferable isocyanate compound. More specifically, the isocyanate compound is a reaction product of an aliphatic, cycloaliphatic or aromatic compounds each having at least two isocyanate groups, preferably an aliphatic or cycloaliphatic compound each having at least two isocyanate groups, with a polyether derivative represented by the general formula (1).

When producing an isocyanate compound described above, the molar ratio between the amount of isocyanate groups in the molecules of the compound having at least two isocyanate groups and the amount of the functional groups each containing an active hydrogen atom in the molecules of the polyether derivative is preferably 1.5/1 to 30/1 and particularly preferably 2/1 to 20/1.

If the reaction molar ratio is 1.5/1 or higher, a sufficient amount of isocyanate groups can be secured in an capsule forming reaction; therefore the capsule forming reaction can be proceeded with ease. On the other hand, if the reaction molar ratio is 30/ 1 or lower, the sensitivity of a heat-sensitive recording material, in which microcapsules of the invention are used, can be enhanced.

The isocyanate compounds can be obtained by agitating the compound having at least two isocyanate groups and the polyether derivative in an organic solvent having no active hydrogen atom at room temperature or at elevated temperature (20 to 80° C.), or by reacting the compound having at least two isocyanate groups with the polyether derivative at a low temperature of about 10 to 60° C. in the presence of a catalyst such as stannous octylate, dibutyl tin diacetate or the like.

Specific examples of the organic solvent having no active hydrogen atom include ethyl acetate, chloroform, tetrahydrofuran, methylethylketone, acetone, acetonitrile, and toluene.

In producing the isocyanate compound, single kind of the compound having at least two isocyanate groups, or plural kinds of the compounds having at least two isocyanate groups may be used, and single kind of the polyether derivative, or plural kinds of the polyether derivatives may be used.

The isocyanate compound is used as a starting material (a capsule wall material) in production of a microcapsule of the invention. In production of a microcapsule of the invention, known compounds each having at least two isocyanate groups in a molecule can also be additionally used together with the isocyanate compound and the specific examples of such known compounds are as described above. In this case, single kind or plural kinds of the isocianate compound(s) may be used, and single kind of plural kinds of the compound(s) having at least two isocyanate groups in a molecule, may be used.

In the production of a microcapsule of the invention, a mass ratio of the amount of the isocyanate compound to the amount of the compound having at least two isocyanate groups in a molecule is preferably in the range of 100/0 to 5/95 and particularly preferably 50/50 to 5/95.

Production of a microcapsule of the invention is conducted by reaction between an isocyanate compound and, for example, a compound having two or more active hydrogen atoms in a molecule. Specific examples of the compound having two or more active hydrogen atoms in a molecule include water, polyhydric alcohols such as ethylene glycol, glycerin, polyamine compounds such as ethylenediamine, diethylenetriamine, and a mixture thereof. Among them, it is particularly preferable to proceed polymerization with water. Microcapsules each having a polyurethane wall and/or polyurea wall are produced by the polymerization.

Other components necessary for producing a microcapsule, that is compounds sealed in a capsule such as a hydrophobic solvent, a water phase can be selected from components known in the art to which the invention pertains. Examples of materials capable of being sealed in a capsule include a perfume oil, a plant protective agent, a reactive adhesive agent, a diazo compound, an electron-donating dye precursor and a medicine, and in a case where a microcapsule of the invention is used in a heat-sensitive recording material, it is preferable to produce microcapsules each encapsulating a diazo compound or an electron-donating dye precursor. In a case where a diazo compound or an electron-donating dye precursor is employed, it is preferable to encapsulate the dye precursor dissolved in a high boiling solvent in the microcapsules.

<Heat-Sensitive Recording Material>

A heat-sensitive recording material of the invention is a heat-sensitive recording material having a heat-sensitive recording layer provided on a support, the heat-sensitive recording layer including (A) a coupler and microcapsules each containing a diazo compound and/or (B) a color developing agent and microcapsules each containing an electron-donating dye precursor, wherein the microcapsules are the microcapsule of the invention.

A multicolor heat-sensitive recording material of the invention comprises, on a support, a heat-sensitive recording layer that develops cyan, a heat-sensitive recording layer that develops magenta, and a heat-sensitive recording layer that develops yellow, wherein each of the heat-sensitive recording layers including (A) a coupler and microcapsules each containing a diazo compound or (B) a color developing agent and microcapsules each containing an electron-donating dye precursor, and at least one kind of the microcapsules are a microcapsule of the invention.

In the invention, in a case where a transparent support is used as the support, a black heat-sensitive recording layer may be provided on a surface of the support opposite to a surface of the support on which the heat-sensitive recording layer is formed.

Detailed description will be given of a microcapsule of a second embodiment of the invention hereinafter. In this embodiment, a microcapsule of the invention is a microcapsule having a polyurea or polyurethane/urea wall, wherein in the microcapsule is produced by polymerizing an isocyanate compounds with a compound having an active hydrogen atom, and at least one kind of the isocyanate compound used is a reaction product of (1) isocyanate compound having two or more isocyanate groups with (2) a polyether derivative having a terminal amino group and represented by the following general formula (1′).

R—O(L-O)ₙ—(X)ₘ-A-NH₂ General formula (1′)

An isocyanate compound and the like used in production of a microcapsule of the invention at least include a reaction product of (1) a polyfunctional isocyanate compound with (2) a polyether derivative represented by the general formula (1′) and can further include known other isocyanate compounds and various kinds of known additives in accordance with the purpose or the necessity. A microcapsule of the invention having a polyurea or polyurethane/urea wall formed by the polymerization of such an isocyanate compound with a compound having an active hydrogen atom has high heat responsiveness, and the microcapsule containing a color developing component shows a high color developability by contact with a coupler or a color developing agent and is also excellent in raw preservability (shelf life).

Detailed description of the major constituents of the invention will be given hereinafter.

(Polyether Derivative Represented by General Formula (1′))

First of all, description of a polyether derivative that has a terminal amino group and is represented by the general formula (1′), will be given.

In the general formula (1′), X represents —CO— or —SO₂— and preferably —CO—.

In the general formula (1′), A represents an arylene group or an alkylene group.

An arylene group represented by A may have a substituent. The arylene group may preferably have 6 to 30 carbon atoms in total and particularly preferably 6 to 20 carbon atoms in total. Preferable examples of the substituent on the arylene group include a halogen atom, an alkyl group, a alkoxy group, an alkoxycarbonyl group, an aryloxycarbonyl group, and an cyano group. Among them, a halogen atom, an alkyl group, and an alkoxy group are particularly preferable. Specific examples of such an arylene group include phenylene, biphenylene, naphthalene, methylphenylene, and methoxyphenylene.

An alkylene group represented by A may have a substituent and may be branched. The alkylene group may preferably have 1 to 30 carbon atoms in total and particularly preferably 1 to 20 carbon atoms in total. Preferable examples of the substituent on the alkylene group include an aryl group, an alkenyl group, an alkoxy group, and an alkoxycarbonyl group. An aryl group is particularly preferable. Specific examples of such an alkylene group include methylene, ethylene, propylene, tetramethylene, and phenylmethylene.

In the general formula (1′), m represents an integer of 0 or 1, preferably represents 1.

Specific examples of the groups represented by —(X)ₘ-A-NH₂ include an aminoethyl group, an aminopropyl group, a 4-aminobenzoil group, a 3-aminobenzoil group, a 4-aminobenzenesulonyl group, an aminoacetyl group, and an aminoethylsulfonyl group.

In the general formula (1′), L represents an alkylene group.

An alkylene group represented by L may have a substituent and may be branched. The alkylene group may preferably have 2 to 20 carbon atoms in total and particularly preferably 2 to 10 carbon atoms in total. Preferable examples of the substituent on the alkylene group include an aryl group, an alkenyl group, an alkoxy group, and acyl group. An aryl group is particularly preferable. Specific examples of such an alkylene group include ethylene, propylene, tetramethylene, phenylethylene, cyclohexylene, vinylethylene, and phenoxymethylethylene.

In the general formula (1′), respective repeating units in —(L-O)ₙ— may independently represent groups, particularly preferably representing the same group. Specific examples of the polyether containing such repeating units include polyethylene oxide, polypropylene oxide, polytetramethylene oxide, polystyrene oxide, polycyclohexylene oxide, polyethylene oxide-polypropylene oxide-block copolymer, and polyethylene oxide-polypropylene oxide random copolymer.

In the general formula (1′), R represents an alkyl group, an aryl group, or an acyl group.

An alkyl group represented by R may have a substituent and may be branched. The alkyl group may preferably have 1 to 30 carbon atoms in total and more preferably 1 to 20 carbon atoms in total. Preferable examples of the substituent include an aryl group, an alkenyl group, and an alkoxy group. Specific examples of such an alkyl group include a methyl group, an ethyl group, a butyl group, an isopropyl group, a behenyl group, a benzyl group, an allyl group, an oleyl group, and methoxyethyl group.

An aryl group represented by R may have a substituent, and may preferably have 6 to 30 carbon atoms in total and particularly preferably 6 to 20 carbon atoms in total. Preferable examples of the substituent include a halogen atom, an alkyl group, an alkenyl group, an alkynyl group, and an alkoxy group. An alkyl group and an alkoxy group are particularly preferable. Specific examples of such an aryl group include a phenyl group, a nonylphenyl group, an octylphenyl group, a fluorophenyl group, a styrylphenyl group, a phenylethenylphenyl group, and a methoxyphenyl group.

An acyl group represented by R may be either aliphatic or aromatic acyl group. The acyl group may have a substituent and may be branched. The acyl group may preferably have 2 to 30 carbon atoms in total and particularly preferably 2 to 20 carbon atoms in total. Examples of the substituent include an alkyl group, an aryl group, an alkenyl group, and an alkoxy group and not including an amino group or a nitro group. Specific examples of such an acyl group include an acetyl group, a benzoyl group, a (meth)acryloyl group, an oleoyl group, a lauroyl group, a stearoyl group, and a methoxybenzoyl group.

Among the groups represented by R described above, an alkyl group and an acyl group are preferable, and an alkyl group is particularly preferable.

In the general formula (1′), n represents an average molar number of addition of a polyether group and represents a number of 10 to 500, preferably 10 to 400 and particularly preferably 10 to 300.

While there are shown hereinafter specific examples of the polyether derivative of the invention which has a terminal amino group and is represented by the general formula (1′), the invention is not limited to the specific examples.

R—O—(CH₂CH₂O)ₙ-X-A-NH₂

| No | R | X-A-NH₂ | n |
|---|---|---|---|
| 1′-1 | CH₃ | 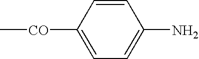 | 98 |
| 1′-2 | CH₃ | 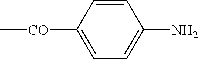 | 113 |
| 1′-3 | CH₃ | 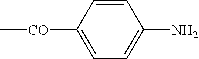 | 45 |
| 1′-4 | CH₃ | 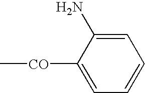 | 45 |
| 1′-5 | CH₃ | 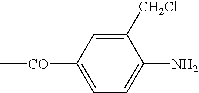 | 17 |
| 1′-6 | CH₃ | 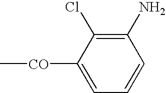 | 98 |
| 1′-7 | CH₃ | 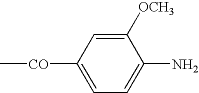 | 113 |
| 1′-8 | C₂H₅ | 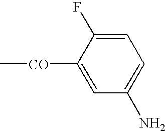 | 220 |
| 1′-9 | C₁₈H₃₇ | 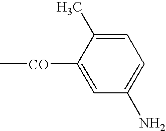 | 110 |
| 1′-10 | C₁₂H₂₅ | 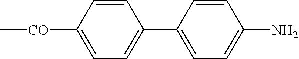 | 98 |
| 1′-11 | 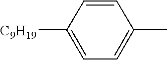 | 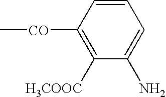 | 90 |
| 1′-12 | 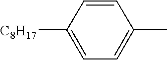 | 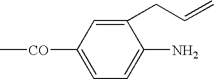 | 98 |
| 1′-13 | 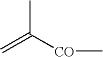 | 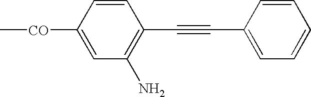 | 98 |
| 1′-14 | C₈H₁₇CH═CHC₇H₁₅CO— | 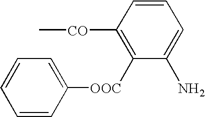 | 98 |
| 1′15 | CH₃ | 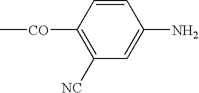 | 98 |
| 1′-16 | CH₃ | 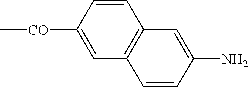 | 90 |
| 1′-17 | CH₃ | 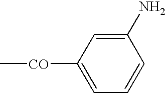 | 45 |
| 1′-18 | CH₃ | 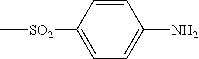 | 98 |
| 1′-19 | CH₃ | 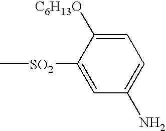 | 113 |
| 1′-20 | CH₃ | —COCH₂NH₂ | 98 |
| 1′-21 | CH₃ | —COCH₂CH₂NH₂ | 45 |
| 1′-22 | C₄H₉ | —CO—(CH₂)₃—NH₂ | 17 |
| 1′-23 | 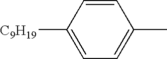 | 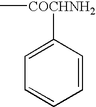 | 113 |
| 1′-24 | C₁₁H₂₃CO— | —SO₂CH₂CH₂NH₂ | 98 |
| 1′-25 | CH₃ | 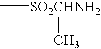 | 113 |

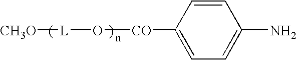

| No | 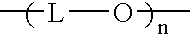 |
|---|---|
| 2′-2 | 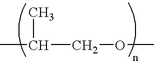 |
| 2′-3 | 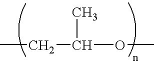 |
| 2′-4 | 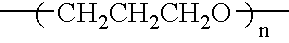 |
| 2′-5 | 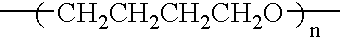 |
| 2′-6 | 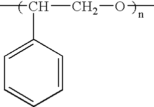 |
| 2′-7 | 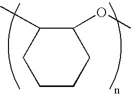 |
| 2′-8 | 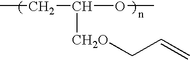 |
| 2′-9 | 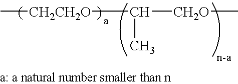 |

R—O—(CH₂CH₂O)ₙ-A-NH₂

| No | R | -A-NH₂ | n |
|---|---|---|---|
| 3′-1 | CH₃ | —CH₂CH₂NH₂ | 113 |
| 3′-2 | CH₃ | —CH₂CH₂NH₂ | 98 |
| 3′-3 | CH₃ | —CH₂CH₂CH₂NH₂ | 98 |
| 3′-4 | CH₃ | —CH₂CH₂CH₂NH₂ | 45 |
| 3′-5 | CH₃ | —(CH₂)₆NH₂ | 30 |
| 3′-6 | C₆H₁₃ | —(CH₂)₉NH₂ | 17 |
| 3′-7 | C₂₂H₄₅ | 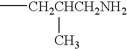 | 300 |
| 3′-8 | 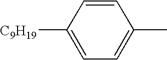 | 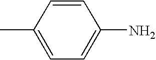 | 500 |
| 3′-9 | 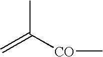 | 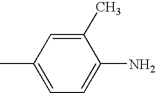 | 98 |
| 3′-10 | C₈H₁₇CH═CHC₇H₁₅CO— | 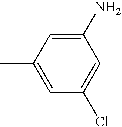 | 113 |

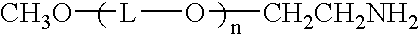

| No | 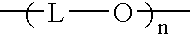 |
|---|---|
| 4′-1 | 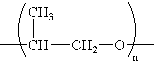 |
| 4′-2 | 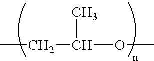 |
| 4′-3 | 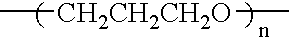 |
| 4′-4 | 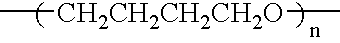 |
| 4′-5 | 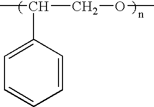 |
| 4′-6 | 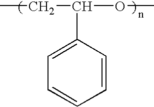 |
| 4′-7 | 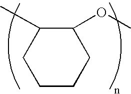 |
| 4′-8 | 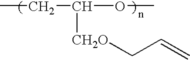 |
| 4′-9 | 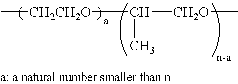 |

(Method of Producing Polyether Derivative Represented by General Formula (1′))

Next, description of a method of producing a polyether derivative of the invention will be given.

A polyether derivative which has a terminal amino group and is represented by the general formula (1′) can be synthesized by a known process, or can be obtained in the market. Regarding known synthetic processes, the following literatures can be referenced: J. Org. Chem., 45, 5364 (1980), JP-A No. 11-263834, Eur. Poly. J., 19, 341 (1983), J. Am. Chem. Soc., 118, 10150 (1996), Tetrahedron Letters, 43, 1529 (2002) and the like.

In a case where m in the general formula (1′) represents 1, the polyether derivative represented by the general formula (1′) (m=1) can be produced by allowing a polyether derivative represented by the following general formula (2′) to react with an aromatic nitro compound represented by the following general formula (3′) to form a nitro compound represented by the following general formula (4′), and hydrogen reducing the nitro compound in the presence of a catalyst for catalytic hydrogen reduction.

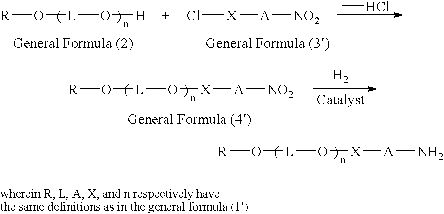

In a reaction between a polyether derivative described above and a aromatic nitro compound, it is preferable to use a base such as triethylamine, pyridine, DBU, sodium hydride. In the reaction, a solvent may also be used. As the solvent, toluene, acetonitrile, tetrahydrofuran, and methylene chloride are preferable. The temperature of the reaction is preferably a temperature of 0° C. to 100° C. or a reflux temperature of the solvent employed in the reaction.

A known catalyst can be used as a catalyst for catalytic hydrogen reduction of the nitro compound represented by the general formula (4′) and detailed information on the catalyst is obtained from Japan Chemical Society (Ed.), Dai-yonban Jikken Kagaku Kouza 26 (Experimental Chemistry Lecture 26),” 4th ed. Tokyo; Maruzen Co., Ltd., 1992; pp.251-266. In the catalytic reduction of the compound represented by the general formula (4′), a solvent may be used. Regarding the solvnet, methanol, ethanol, 2-propanol, tetrahydrofuran, and chloroform are preferable. The temperature of the hydrogen reduction is preferably a temperature of 0° C. to 60° C. or a reflux temperature of the solvent employed in the reaction.

(Microcapsule)

A microcapsule of the second embodiment of the invention is a microcapsule having a polyurea or polyurethane/urea wall produced by polymerizing an isocyanate compound including a reaction product of (1) isocyanate compound having at least two isocyanate groups and (2) a polyether derivative having a terminal amino group and represented by the following general formula (1′), by using a compound having an active hydrogen atom.

A preferable isocyanate compound used according to the invention is a reaction product that includes an urea group as a bond, which is obtained by a reaction of (1) a polyfunctional isocyanate compound having two or more functional groups with (2) a polyether derivative that has an amino group at a terminal and is represented by the general formula (1′).

To be more detailed, an isocyanate compound used according to the invention is a reaction product obtained by a reaction of (1) an aliphatic and cycloaliphatic; and/or an aromatic polyfunctional isocyanate compound, preferably an aliphatic and/or cycloaliphatic polyfunctional isocyanate, each having at least two, preferably at least three, functional groups, with (2) a polyether derivative that has an amino group at a terminal and is represented by the general formula (1′).

Compounds each having two isocyanate groups in a molecule as specific examples of the isocyanate compounds having at least two isocyanate groups, which can be used in the above reaction include: m-phenylenediisocyanate; p-phenylenediisocyanate; 2,6-tolylenediioscyanate; 2,4-tolylenediioscyanate; naphthalene-1,4-diisocyanate; diphenylmethane-4,4′-diisocyanate; 3,3′-dimethoxy-biphenyldiisocyanate; 3,3′-dimethyldiphenylmethane-4,4′-diisocyanate; xylylene-1,4-diisocyanate; xylylene-1,3-diisocyanate; 4-chloroxylylene-1,3-diisocyanate; 2-methylxylylene-1,3-diisocyanate; 4,4′-diphenylpropanediisocyanate; 4,4′-diphenylhexafluoropropanediisocyanate; trimethylenediisocyanate; hexamethylenediisocyanate; propylene-1,2-diisocyanate; butylene-1,2-diisocyanate; cyclohexylene-1,2-diisocyanate; cyclohexylene-1,3- diisocyanate; cyclohexylene-1,4-diisocyanate; dicyclohexylmethane-4,4′-diisocyanate; 1,4-bis(isocyanatemethyl)cyclohexane; 1,3-bis(isocyanatemethyl)cyclohexane, isophoroneisocyanate; and lysinediisocyantate. Adducts of the difunctional isocyanate compounds described above with difunctional alcohols such as ethylene glycols and bisphenols, or with phenols, can also be used.

Further, polyfunctional isocyanate compounds can also be used. Examples of such polyfunctional isocyanate compounds include: a trimer (a buret compound or isocyanurate) containing the difunctional isocyanate compound described above as a main monomer component; a polyfunctional adduct of a polyol such as trimethylolpropane with a difunctional isocyanate compound; a polymer compound of an isocyanate compound having a polymerizable group, such as a formalin condensate of a benzeneisocyanate and methacryloyloxyethylisocyanate; and a lysinetriisocyanate.

Particularly, a trimer (buret compounds or isocyanurate) containing at least one of xylylenediisocyanate, a hydrogenated compound thereof, hexamethylenediisocyanate, tolylene diisicyanate, and a hydrogenated compound thereof, as a main raw material; and polyfunctional adducts of trimethylolpropane with a difunctional isocyanate compound are preferable. Such compounds are recited in Keiji Iwata (Ed.), Polyurethane Jushi Handbook (Polyurethane Resin Hand Book) The Nikkan Kogyo Shimbun, Ltd., 1987.

Among them, 2,4-tolylene diisocyanate, 2,6,-tolylene diisocyanate, xylylene-1,4-diisocyanate, xylylene-1,3-diisocyanate and adducts of trimethylolpropane with xylylene-1,4-diisocyanate or xylylene-1,3-diisocyanate are preferable. Xylylene-1,4-diisocyanate, xylylene-1,3-diisocyanate and adducts of trimethylolpropane with xylylene-1,4-diisocyanate or xylylene-1,3-diisocyanate are particularly preferable.

In the invention, a molar reaction ratio of a polyether derivative that has an amino group at a terminal and is represented by the general formula (1′), to an isocyanate compound having at least two isocyanate groups, is preferably in the range of 1/100 to 50/100 and particularly preferably in the range of 2/100 to 40/100. If the molar reaction ratio is less than 1/100, an effect of sensitivity improvement is insufficient in some cases, while if the molar reaction ratio is in excess of 50/100, the capsule formation is difficult because a residual amount of an isocyanate group is too small in some cases.

An addition reaction of the polyether derivative that has an amino group at a terminal and is represented by the general formula (1′) with the isocyanate having at least two isocyanate groups, can be proceeded, for example, in an organic solvent having no active hydrogen atom at room temperature or at an elevated temperature of about 20 to 80° C. while the solvent is agitated. Examples of the organic solvent include ethylacetate, chloroform, tetrahydrofuran, methyl ethyl ketone, aceton, acetonitrile, and toluene.

Note that one kind of or plural kinds of adduct(s) of a polyether derivative that has an amino group at a terminal and is represented by the general formula (1′) with an isocyanate having at least two isocyanate group may be used as the isocyanate compound in the invention.

A known polyfunctional isocyanate having at least two isocyanate groups can be additionally used together with the adducts of a polyether derivative that has an amino group at a terminal and is represented by the general formula (1′) of the invention with an isocyanate compound having at least two isocyanate groups, as a starting material of the production of the microcapsule. Examples of such additional polyfunctional isocyanate include the compounds represented above as the difunctional isocyanates, which can be used in a proper portion.

The polyfunctional isocyanate compounds may be used either singly or in combination of two or more kinds. In a case where a polyfunctional isocyanate is additionally used together with a reaction product of a polyether derivative that has an amino group at a terminal and is represented by the general formula (1′) with an isocyanate having at least two isocyanate groups, a mass ratio of the reaction product to a polyfunctional isocyanate as an additive is preferably in the range of 100/0 to 10/90 and more preferably in the range of 90/10 to 15/85.

Polymerization of an isocyanate compound of the invention with an active hydrogen atom is conducted by a reaction of the isocyanate compound with a compound having a two or more active hydrogen atoms in a molecule thereof. Examples of such an active hydrogen compound include water, polyhydric alcohols such as ethylene glycol and glycerin, polyamine compounds such as ethylene diamine and diethylene triamine, and a mixture thereof. It is particularly preferable to perform polymerization with water. The polymerization results in formation of a polyurea or polyurethane/polyurea wall.

Other components necessary for producing a microcapsule, that is materials sealed in the capsule, a hydrophobic solvent, and a water phase can be selected within the current state of the art to which the invention pertains. Examples of materials capable of being sealed in a capsule include a perfume oil, a plant protective agent, a reactive adhesive agent, and a medicine. In the invention, it is preferable to produce microcapsules each containing a diazo compound or an electron-donating dye precursor. In a case where a diazo compound or an electron-donating dye precursor, are used, the diazo compound or the dye precursor is contained inside the microcapsule preferably being dissolved in a solvent having a high boiling point.

A heat-sensitive recording material of the invention has a fundamental structure in which a heat-sensitive recording layer including microcapsules described above is provided on a support. A multicolor heat-sensitive recording material of the invention has a fundamental structure in which heat-sensitive recording layers respectively including microcapsules for cyan, magenta and yellow, is provided on a (transparent) support, wherein at least one kind of the microcapsules is the microcapsule described above. A heat-sensitive recording layer for black may be provided on a rear surface of the transparent support if necessary.

Detailed description will be given of components and the like used commonly in both embodiments of the invention.

Examples of the electron-donating dye precursor contained in a microcapsule of the invention include a triarylmethane compound, a diphenylmethane compound, a thiazine compound, a xanthene compound, and a spiropyrane compound. Particularly, triarylmethane compound and a xanthene compound are highly useful because such compounds give high color density.

Specific examples of the electron-donating dye precursor include: 3,3-bis(p-dimethylphenyl)-6-dimethylaminophthalide (namely, crystalvioletlactone); 3,3-bid (p-dimethylamino)phthalide; 3-(p-dimethylaminophenyl)-3- (1,3-dimethylindole-3-yl)phthalide; 3-(p-dimethylaminophenyl)-3-(2-methylindole-3-yl)phthalide; 3-(o-methyl-p-dimethylaminophenyl)-3-(2-methylindole-3-yl)phthalide; 3-(o-methyl-p-diethylaminophenyl)-3-(1′-ethyl-2-methylindole-3-yl)phthalide; 4,4-bis(dimethylamino)benzhydrinbenzyl ether; N-halophenylleucoauramine; N-2,4,5-trichlorophenylleucoauramine; rhodamine-B-anilinolactam; rhodamine (p-nitroanilino)lactam; rhodamine-B-(p-chloroanilino)lactam; 2-benzylamino-6-diehtylaminofluoran; 2-anilino-6-diethylaminofluoran; 2-anilino-3-methyl-6-diethylaminofluoran; 2-anilino-3-methyl-6-cyclohexylmethylaminofluoran; 2-anilino-3-methyl-6-isoamylethylaminofluoran; 2-(o-chloroanilino)-6-diethylaminofluoran; 2-octylamino-6-diethylaminofluoran; 2-ethoxyethylamino-3-chloro-2-diethylaminofluoran; 2-anilino-3-chloro-6-diethylaminofluoran; benzoylleucomethyleneblue; p-nirobenzylleucomethyleneblue; 3-methyl-spiro-dinaphthopyran; 3-ethyl-spiro-dinaphthopyran; 3,3′-dichloro-spiro-dinaphthopyran; 3-benzyl-spiro-dinaphtopyran; 3-propyl-spiro-dibenzopyran.

The electron-donating dye precursors may be used either singly or in combination of two or more kinds.

Examples of an electron-accepting compound (a color developing agent (not contained in a microcapsule)) used in combination with an electron-donating dye precursor described above include a phenol derivative, a salicylic acid derivative, and a hydroxybenzoic acid ester. Among them, bisphenols and hydroxybenzoic acid esters are particularly preferable.

More specific examples thereof include: 2,2-bis(p-hydroxyphenyl) propane (bisphenolA); 2,2-bis(p-hydroxyphenyl)pentane; 2,2-bis(p-hydroxyphenyl) ethane; 2,2-bis(p-hydroxyphenyl)butane; 2,2-bis(4′-hydroxy-3,5′,dichlorophenyl)propane; 1,1-(p-hydroxyphenyl)cyclohexane; 1,1(p-hydroxyphenyl)propane; 1,1-(p-hydroxyphenyl)pentane; 1,1(p-hydroxyphenyl)-2-ethylhexane; 3,5-di(α-methylbenzyl)salicylic acid and a polyvalent metal salt thereof; 3,5-di(tert-butyl)salicylic acid and a polyvalent metal salt thereof; 3-α,α-dimethylbenzylsalicylic acid and a polyvalent metal salt thereof; butyl p-hydroxybenzoate; benzyl p-hydroxybenzoate; 2-ethylhexyl p-hydroxybenzoate; p-phenylphenol; and p-cumylphenol.

The electron-accepting compounds may be used either singly or in combination of plural kinds, and the electron-accepting compounds can be used at any ratio in a case where the compounds are used in combination.

It is preferable to add a sensitizer for promoting a reaction in the heat-sensitive layer. A preferable compound as the sensitizer is an organic compound having a low melting point, and appropriately having an aromatic group or aromatic groups, and a polar group or polar groups in a molecule thereof. Specific examples thereof include: benzyl p-benzyloxybenzoate; α-naphthylbenzyl ether; β-naphthylbenzyl ether; phenyl β-naphthoate; phenyl α-hydroxy-β-naphtoate; β-naphthol-(p-clorobenzyl) ether; 1,4-butanediolphenyl ether; 1,4-butanediol-p-methylphenyl ether; 1,4-butanediol-p-ethylphenyl ether; 1,4-butanediol-m-methylphenyl ether; 1-phenoxy-2-(p-tolyloxy)ethane; 1-phenoxy-2-(p-ethylphenoxy)ethane; 1-phenoxy-2-(p-chlorophenoxy)ethane; p-benzylbiphenyl; p-toluenesulfonamide; 4-(2-ethylhexyloxy)phenylsulfonamide; and 4-n-pentyloxyphenylsulfonamide.

The sensitizers may be used either singly or in combination of plural kinds. In a case where the sensitizers are used in combination, they can be used at any ratio.

A diazo compound contained in a microcapsule of the invention can be a known diazo compound. The diazo compound herein is defined as a compound represented by the following general formula.

ArN₂X⁻

wherein, in the formula, Ar represents an aryl group and X⁻ represents an acid anion.

The diazo compound can react with a phenol compound or a compound having an active methylene to form a so-called dye and is decomposed under irradiation with light (ultraviolet in general) to be denitrified and lose its reaction activity.

Specific examples of the diazo compound described above can include salts of the following compounds:

2,5-dibutoxy-4-morphorinobenzenediazonium;

2,5-octoxy-4-morphorinobenzenediazonium;

2,5,-dibutoxy-4-(N-(2-ethylhexanoyl)piperazino) benzenediazonium;

2,5-diethoxy-4-(N-(2-(2,4-di-tertamylphenoxy)butylyl)piperazino) benzenediazonium;

2,5-dibutoxy-4-tolylthiobenzenediazonium;

2,5-dibutoxy-4-chlorobenzenethiodiazonium;

2,5-diheptyloxy-4-chlorobenzenethiodiazonium;

3-(2-octyloxyethoxy)-4-morphorinobenzenediazonium;

4-N,N-dihexylamino-2-hexyloxybenzenediazonium;

4-(N-hexyl-N-(1-methyl-2-(p-methoxyphenoxy)ethyl)amino)-2-hexyloxybenzene diazonium; and

4-N-hexyl-N-tolylamino-2-hexyloxybenzenediazonium.

Examples of compounds used as an acid anion of the diazo compound can include: a hexafluorophosphate salt; a tetrafluoroborate salt; 1,5-naphthalenesulfonate salt; a perfluoroalkylcarbonate salt; a perfluoroalkylsulfonate salt; zinc chloride salt; and tin chloride salt. Among them, a hexafluorophosphate salt, a tetrafluoroborate salt, and a 1,5-naphthalenesuofonate salt are preferable, since such salts have low solubility to water, and is soluble in an organic solvent.

The diazo compounds described above may be used either singly or in combination of plural kinds. In a case where the diazo compounds are used in combination, they can be used at any ratio.

In a heat-sensitive recording layer including microcapsules each containing a diazo compound, a known heat sensitizer such as an arylsulfonamide compound may be added. Specifically, toluenesulfonamide and ethylbenzenesulfonamide and the like may be used.

The heat sensitizers may be used either singly or in combination of plural kinds.

A coupler that reacts with a diazo compound to form a colorant is used in a state of fine particles obtained by emulsified dispersion and/or solid dispersion.

Specific examples of the coupler include: resorcin; phloroglucin, sodium 2,3-dihydroxynaphthalene-6-sulfonate, 1-hydroxy-2-naphthoic acid morphrinopropylamide; 1,5-dihydroxynaphthalene; 2,3-dihydroxynaphthalene; 2,3-dihydroxy-6-sulfanilnaphthalene; 2-hydroxy-3-naphthoic acid anilide; 2-hydroxy-3-naphthoic acid ethanolamide; 2-hydroxy-3-naphthoic acid octylamide; 2-hydroxy-3-naphthoic acid-N-dodecyloxypurpylamide; 2-hydroxy-3-naphthoic acid tetradecylamide; acetoanilide; acetoacetoanilide; benzoylacetoanilide; 2-chloro-5-octylacetoacetoanilide; 2,5,-di-n-heptyloxyacetoanilide; 1-phenyl-3-methyl-5-pyrazolone; 1-(2′-octylphenyl)-3-methyl-5-pyrazolone; 1-(2′,4′,6′-trichlorophenyl)-3-benzamide-5-pyrazolone; 1-(2′,4′,6′-trichlorophenyl)-3-anilino-5-pyrazolone; 1-phenyl-3-phenylacetoamide-5-pyrazolone; 1-(2-dodecyloxyphenyl)-2-methylcarbonate cyclohexane-3,5-dion; 1(2-dodecyloxyphenyl)cyclohexane-3,5-dion; N-phenyl-N-dodecylbarbituric acid; N-phenyl-N-(2,5-dioctyloxyphenyl)barbituric acid; and N-phenyl-N-(3-stearyloxy)butylbarbituric acid.

The couplers may be used either singly or in combination of plural kinds. It is also possible to use a combination of plural kinds of the couplers to develop a color having a desired hue.

In order to promote a pigment forming reaction, it is general to add a basic compound in the shape of fine particles obtained by emulsion dispersing and/or solid dispersing. The basic compounds include an inorganic basic compound and an organic basic compound; and in addition, a compound releasing an alkali material when being heated by, for example, decomposition. Typical examples thereof include: organic ammonium salts; organic amines; amide; urea, thiourea and derivatives thereof; and nitrogen containing compounds such as thiazoles, pyrroles, pyrimidines, piperazines, guanidines, indoles; imidazoles; imidazolines, triazoles, morphorines, piperidines, amidines, formazines, pyridines.

Specific examples thereof include: tricyclohexylamine; tribenzylamine; octadecylbenzylamine; stearylamine; arylurea; thiourea; methylthiourea; arylthiourea; ethylenethiourea; 2-benzylimidazole; 4-phenylimidazole; 2-phenyl-4-methylimidazole; 2-undecylimidazoline; 2,4,5-trifuril-2-imidazoline; 1,2-diphenyl4,4-dimethyl-2-imidazoline; 2-phenyl-2-imidazoline; 1,2,3-triphenylguanidine; 1,2-dicyclohexylguanidine; 1,2,3-tricyclohexylguanidine; guanidine trichloroacetate; N,N′-dibenzylpyperazine; 4,4′-dithiomorpholine; morpholinium trichloroacetate salt; 2-aminobenzothiazole; and 2-benzoylhydrazinobenzothiazole.

The basic compounds may be used either singly or in combination of plural kinds.

Production of a microcapsule of the invention is performed in the following way, for example.

An organic solvent having a boiling point in the range of 100 to 300° C. is preferably used as a hydrophobic solvent for forming a core of a microcapsule. Specific examples of the organic solvent include: alkylnaphthalene; alkyldiphenylethane; alkyldiphenylmethane; an alkyl adduct of diphenylethane; alkylbiphenyl; chlorinated paraphine; phosphoric acid based derivatives such as tricresyl phosphate; maleic acid esters such as maleic acid-di-2-ethylhexyl; and adipic acid esters. The organic solvents may be used in combination of plural kinds. In a case where solubilities of the diazonium salt compound and the electron-donating dye precursor to the hydrophobic solvent are insufficient, a solvent having a low boiling point can be additionally used. An organic solvent having a boiling point in the range of 40 to 100° C. is preferably used as the solvent having a low boiling point which is additionally used. Specific examples thereof include: ethylacetate; butyl acetate; methylene chloride; tetrahydrofuran; and acetone. The organic solvents can also be used in combination of plural kinds. In a case where only a solvent having a low boiling point (about 100° C. or less) is used in a capsule core, the solvent evaporates away to easily form a so-called a coreless capsule only containing a capsule wall, a diazonium salt compound, and an electron-donating dye precursor.

Depending on the kind of the diazo compound, the diazo compound may migrates into an aqueous phase in a reaction of forming a microcapsule. In order to suppress this migration, an acid anion may be properly added in an water-soluble polymer solution in advance. Examples of such an acid anion include: PF₆⁻; B (—Ph)₄⁻ (Ph represents a phenyl); ZnCl₂⁻; CnH₂ₙ₊₁COO⁻ (n is an integer of 1 to 9); and CₚF₂ₚ₊₁SO₃⁻ (p is an integer of 1 to 9).

For the purposes such as improving storage stability and adjusting color developing sensitivity, various kinds of additives can additionally be used.

In a case where a microcapsule is formed in the invention, water is generally used as a compound having an active hydrogen atom used in polymerization of the isocyanate compound for forming a wall of the microcapsule, while a polyol may be added, as a compound having an active hydrogen atom (one component among starting materials for the microcapsule wall), into the organic solvent which will serve as a core or into a water-soluble polymer solution which will serve as a dispersion medium. Specific examples of the polyols include propylene glycol, glycerin, and trimethylolpropane. Amine compounds such as diethylenetriamine and tetraethylenepentamine can be used instead of the polyol or together with the polyol. Such compounds are also described in “Polyurethane Resin Hand Book” shown above.

Examples of the water-soluble polymer serving for dispersing the oil phase of microcapsules in the water phase include: polyvinyl alcohol and a modified compound thereof; polyacrylic acid amide and a derivative thereof; ethylene/vinyl acetate copolymer; styrene/maleic anhydride copolymer; ethylene/maleic anhydride copolymer; isobutylene/maleic anhydride copolymer; polyvinyl pyrrolidone; ethylene/acrylic acid copolymer; vinyl acetate/acrylic acid copolymer; carboxymethylcellulose; methylcellulose; casein; gelatin; a starch derivative, gum arabic; and sodium alginate. It is preferable that the water-soluble polymers do not react with or hardly react with the isocyanate compound. Thus, if a compound having a reactive amino group in a molecular chain such as gelatin, is used, it is necessary to deprive the molecule of the reactivity in advance.

In the invention, a surfactant, when used, may be added into any of an oil phase and a water phase, while it is easier to add the surfactant into the water phase because the surfactant has lower solubility to an organic solvent. The amount of the surfactant to be added is preferably in the range of 0.1 to 5% by mass and more preferably in the range of 0.5 to 2% by mass with respect to the mass of the oil phase. Of surfactants generally used in emulsified dispersion, it has been thought that a surfactant having a relatively long-chained, hydrophobic group is excellent (see Ichiro Nishi et al. (Ed.) Kaimen Kasseizai Binran (Surfactant Hand Book) Sangyo-tosho, 1980). Examples of the surfactant usable include alkali metal salts of alkylsulfonic acid and alkylbenzenesulfonic acid.

In the invention, compounds such as a formalin condensate of an aromatic sulfonate and a formalin condensate of an aromatic carboxylate, represented by the following general formula (A) can also be used as a surfactant (an emulsion auxiliary).

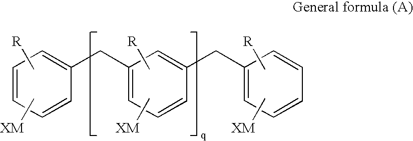

In the formula (A), R represents an alkyl group having 1 to 4 carbon atoms, X represents SO₃⁻ or COO⁻, M represents a sodium atom or a potassium atom, and q represents an integer of 1 to 20. Compounds represented by the general formula (A) are described in JP-A No. 6-297856.

An alkoxyglucoside compound represented by the following general formula (B) can also be used.

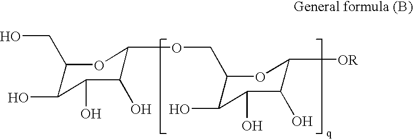

In the general formula (B), R represents an alkyl group having 4 to 18 carbon atoms and q represents an integer of 0 to 2.

In the invention, the surfactants may be used either singly or in combination of plural kinds.

A mixture (an oil phase) of a solution including the diazo compound (or an electron-donating dye precursor) described above and a solvent having a high boiling point, and an isocyanate compound of the first embodiment or a polyfunctional compound (adduct) of the second embodiment is added into an aqueous solution (a water phase) including a surfactant and a water-soluble polymer. At that time, the mixture is added into the aqueous solution while the aqueous solution is agitated with a high shear agitator such as a homogenizer to thereby emulsion-disperse the mixture. After the emulsification, a capsule wall forming reaction is proceeded by adding a polymerization reaction catalyst for the isocyanate compound or elevating the temperature of the emulsion.

A coupling reaction deactivating agent can further be added into thus prepared microcapsule liquid including a diazo compound, in accordance with the necessity. Examples of the deactivating agent can include: hydroquinone; sodium hydrogen sulfite, potassium nitrite; hypophosphorous acid; stannous chloride; and formalin. These compounds are described in JP-A No. 60-214992.

In most of cases, a diazo compound usually dissolve to the water phase during the formation of a capsule. For removing the dissolved diazo compound, methods such as filtration; ionic exchange; electrophoreisis; a chromatographic treatment; gel filteration; reverse osmosis; ultrafiltration; dialysis, and an active charcoal treatment, can be employed. Among them, ionic exchange, reverse osmosis, ultrafiltration, and dialysis, are preferable. A treatment with a cation exchanger, and a treatment with both a cation exchanger and an anion exchanger, are particularly preferable. These methods are described in JP-A No. 61-219688.

In the invention, compounds such as an electron-accepting compound, a heat sensitizer, a coupler, and a basic compound can be added into the heat-sensitive recording layer. The compounds may be separately added after being emulsion dispersed or solid dispersed (dispersion of fine particles). Alternatively the compounds may be added after the compounds are properly mixed, and emulsion dispersed or solid dispersed (dispersion of fine particles). The method of emulsion dispersing includes dissolving the compounds into an organic solvent and adding the obtained solution into the aqueous solution of water-soluble polymer while the aqueous solution of water-soluble polymer is agitated with a homogenizer or the like. For accelerating pulverization, it is preferable to use the hydrophobic organic solvent, the surfactant and the water-soluble polymer, which are described above.

Solid dispersing of the coupler, the basic compound, the electron-accepting compound, the heat sensitizer and the like is achieved by adding the powder of the respective compounds to the aqueous solution of water-soluble polymer and making the powder fine by using a known dispersing means such as a ball mill. By the process of the formation of the fine particles, respective fine particles preferably made to have the particle diameters that satisfy the characteristics required for a heat-sensitive recording material and a production method thereof such as a heat sensitivity, preservability, a transparency of a recording layer, production adaptability.

A microcapsule liquid described above, and a prepared solution or solutions including compounds such as a heat sensitizer, an electron-accepting compound, a coupler, and/or a basic compound, are mixed at a proper ratio and applied on a support. A coupler is used generally in the range of 1 to 10 mol and preferably in the range of 2 to 6 mol with respect to 1 mol of a diazo compound. The most preferable amount of addition of a basic compound is generally in the range of 0.5 to 5 mol with respect to 1 mol of a diazo compound, though depending on the alkali strength of the compound.

An electron-accepting compound (a color developing agent) is generally added in the range of 0.5 to 30 mol, and preferably in the range of 1 to 20 mol with respect to 1 mol of an electrondonating dye precursor. The electron-accepting compound is more preferably added in the range of 3 to 15 mol. A heat sensitizer is generally added in the range of 0.1 to 20 mol and preferably in the range of 0.5 to 10 mol with respect to 1 mol of the electron-donating dye precursor.

As a support on which the coating solutions are coated, a known material for a support of a heat-sensitive recording material can be employed. Available examples thereof include: paper; coated paper on which clay or the like is coated; laminate paper obtained by laminating polyethylene, polyester or the like on paper; synthetic paper, and plastic films made of plastics such as polyethyleneterephthalate, polyimide, triacetylcellulose, and the like. Examples of a transparent support include plastic films made of plastics such as polystyrene, polypropylene, and polyethylene in addition to the plastic films made of the above mentioned polyethyleneterephthalate and triacetylcellulose.

In the invention, a protective layer may be provided on a heat-sensitive recording layer for further improving characteristics such as light fastness. In a multicolor heat-sensitive recording material, an intermediate layer may also be provided between heat-sensitive recording layers for further improving the color reproducibility. A material used in the protective layer and the intermediate layer is preferably an emulsion (latex) of a water-soluble polymer compound or a hydrophobic polymer compound.

Description of a multicolor heat-sensitive recording material and a recording method thereof according to the invention will be given. First of all, the outermost heat sensitive layer (a first heat-sensitive layer, which is usually an yellow developing layer) including a diazo compound is developed by thermal recording at a low energy, and thereafter the entire surface of the outermost heat sensitive layer is illuminated with light emitted from a light source emitting light within the absorption wavelength range of a diazo compound included in the outermost heat sensitive layer to cause a residual diazo compound in the outermost heat sensitive layer to be photodecomposed.

Then, a second heat-sensitive recording layer (which is usually a magenta developing layer) including a diazo compound having a light absorption wavelength range which is different from the light absorption wavelength range of the diazo compound included in the first layer, is developed at an energy higher than that in the case of the first heat-sensitive recording layer. Thereafter, the entire surface of the outermost heat sensitive layer is again illuminated with light emitted from a light source emitting light within the absorption wavelength range of the diazo compound in the second heat-sensitive recording layer to cause a residual diazo compound included in the second heart-sensitive recording layer to be photodecomposed. Finally, the innermost layer (a third heat-sensitive recording layer, which is usually a cyan developing layer) including an electron-donating dye precursor is developed at further higher energy to complete image recording.

In the above case, the outermost layer and the second layer are preferably transparent since color development in the respective layers becomes sharp. In the invention, a multicolor image can also be obtained by employing a transparent support and coating one of the three layers described above on the rear surface of the transparent support. In this case, no necessity arises for the transparency of the outermost heat-sensitive layer on the side of the support opposite to the viewer's side.

The light source used in the photodecomposition of the diazo compounds is usually an ultraviolet lamp. The ultraviolet lamp is a fluorescent tube including mercury vapor inside. Fluorescent tubes having various kinds of light emitting wavelengths can be obtained by using different kinds of phosphors.

In a multicolor heat-sensitive recording material, the third heat-sensitive recording layer can also be produced using a proper combination of a diazo compound and a coupler compound.

### EXAMPLES

Examples of the invention are shown hereinafter, however, the invention is not limited to the examples. Note that in the examples, “a part”, “parts”, and “%” denote “a part by mass”, “parts by mass” and “% by mass” respectively.

### Synthesis Example 1

10 parts of the polyether derivative 1-1, which is shown above as an example of the polyether derivative according to the invention, was dried at an environmental temperature of 80° C. for 2 hours by using a vacuum pump, thereafter, the environmental temperature was lowered to room temperature. Then, 11 parts of dry ethyl acetate and 1.03 parts of xylylene-1,3-diisocyanate were added to the polyether derivative in a nitrogen stream, the mixture was agitated at 50° C. for 3 hours, and a solution (50% by mass) of an isocyanate compound (1) was obtained.

### Synthesis Example 2

A solution (50% by mass) of an isocyanate compound (2) was obtained in the same manner as that in the case of Synthesis Example 1, except that the polyether derivative 1-1 in Synthesis Example 1 was replaced with the polyether derivative 1-2, which is shown above as an example of the polyether derivative according to the invention.

### Synthesis Example 3

A solution (50% by mass) of an isocyanate compound (3) was obtained in the same manner as that in the case of Synthesis Example 1, except that the polyether derivative 1-1 in Synthesis Example 1 was replaced with the polyether derivative 1-3, which is shown above as an example of the polyether derivative according to the invention.

### Synthesis Example 4

A solution (50% by mass) of an isocyanate compound (4) was obtained in the same manner as that in the case of Synthesis Example 1, except that the polyether derivative 1-1 in Synthesis Example 1 was replaced with the polyether derivative 1-4, which is shown above as an example of the polyether derivative according to the invention.

### Example 1

(Preparation of Heat-Sensitive Recording Layer Coating Solution (A))

Preparation of Microcapsule liquid in Which Microcapsules Include Diazo Compound

3.5 parts of the following compound (A-1) having the maximum absorption wavelength for decomposition at 420 nm and 0.9 part of a compound (A-2) as diazo compounds, were dissolved into 16.4 parts of ethyl acetate. 7.3 parts of isopropylbiphenyl, which is a solvent having a high boiling point, and 2.5 parts of diphenyl phthalate were further added into the solution. The obtained solution was heated and uniformly mixed.

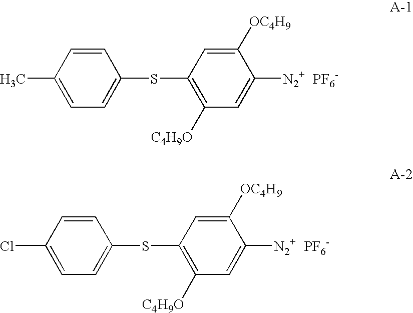

To the obtained mixture, 7.7 parts of a mixture obtained by mixing 4.5 parts of xylylenediisocyanate /trimethylolpropane adduct (in the form of a 75% by mass ethyl acetate solution manufactured by Mitsui Takeda Chemical Industries, Ltd. with a trade name TAKENATE D110N) and 4.5 parts of a 30% by mass solution in ethyl acetate of xylylenediisocyanate/bisphenol A adduct synthesized according to the method described in JP-A No. 07-088356, and 0.86 part of the isocyanate compound (1) described in Synthesis Example 1 were added as capsule wall materials. The mixture was agitated to be a homogenous mixture. 77 parts of an 8% by mass phthalated gelatin aqueous solution including 0.36 part of SCRAPH AG-8 (manufactured by Nippon Fine Chemical Co., Ltd.), was separately prepared and mixed with said mixture containing the diazo compounds. The obtained mixture was emulsion dispersed by using a homegenizer. 20 parts of water was added and the emulsion was made homogeneous. The capsule forming reaction was conducted for 3 hours while the emulsion is agitated at 40° C. Thereafter, the temperature of the emulsion was lowered to 35° C. and 4.1 parts of ion exchange resin AMBERLITE IRA68 (manufactured by Organo Corporation) and 8.2 parts of ion exchange resin AMBERLITE IRC50 (manufactured by Organo Corporation) were added into the emulsion. The emulsion was further agitated for 1 hour. Thereafter, the ion exchange resin was filtrated out and the concentration of solids in the microcapsule liquid was adjusted to 20.0%. Thereby, the microcapsule liquid in which microcapsules included a diazo compound was obtained. The particle diameters of the obtained microcapsules were measured with a particle diameter distribution measuring instrument (fabricated by Horiba, Ltd., with a trade name of LA-700), and the median diameter of the particles was found to be 1.51 μm.

Preparation of Coupler Emulsified Dispersion

As couplers, 2.4 parts of 2,5-di-n-heptyloxyacetoanilide, 2.5 parts of triphenylguanidine, 3.3 parts of 4-(2-ethylhexyloxy)phenylsulfonamide, 1.7 parts of 4-n-pentyloxyphenylsulfonamide and 5.0 parts of 4,4′-(m-phenylenediisopropylidene)diphenol, were dissolved into 8.0 parts of ethyl acetate. 1.0 part of PIONIN A41C (manufactured by Takemoto Oil & Fat Co., Ltd.) was further added into the coupler solution. The mixture was heated and uniformly mixed. The mixture was added into 75.0 parts of a separately prepared, 10% by mass aqueous solution of gelatin (manufactured by Nitta Gelatin Co., Ltd. with a trade name of #750). This mixture was emulsion dispersed at 40° C. by using a homogenizer. Residual ethyl acetate was evaporated off from the emulsified dispersion so as to adjust the concentration of solids to 26.5% by mass.

Then, 9 parts of an SBR latex solution obtained by adjusting the concentration of SBR latex (a 48% solution, manufactured by Nippon A & L Inc. with a trade name SN-307) to 26.5% was added into 100 parts of the coupler emulsified dispersion described above. The emulsified dispersion was agitated homogeneously to obtain a coupler emulsified dispersion.

Preparation of Heat Sensitive Recording Layer Coating Solution (A)

The microcapsule liquid in which the microcapsules included the diazo compound and the coupler emulsified dispersion were mixed together so that a mass ratio of the diazo compound/ the coupler compound became 1/3.2, thereby, heat-sensitive recording layer coating solution (A) was obtained.

(Preparation of Heat-Sensitive Protective Layer Coating Solution (D))

2.0 parts by mass of a 20.5% by mass zinc stearate dispersion (manufactured by Chukyo Oil & Fat Co., Ltd. with a trade name HYDRIN F115) was added into 61 parts of 5.0% by mass itaconic acid modified polyvinyl alcohol (manufactured by Kuraray Co., Ltd. with a trade name of KL-318). Further, 8.4 parts of a 2% by mass aqueous solution of the following compound (D1), 8.0 parts of a fluorine-type releasing agent (manufactured by DAIKIN INDUSTRIES LTD. with a trade name of ME-313), and 0.5 part of flour starch (manufactured by Kagoshima Denpun K.K. with a trade name of KF-4) were added to the mixture. Then the mixture were agitated uniformly. This mixture is called “a mother solution” hereinafter.

C₁₂H₂₅O—(C₂H₄O)₁₀—H (D-1)

Separately, 12.5 parts of a 20% by mass ion-exchanged, aqueous solution of KAOGLOSS (manufactured by Shiraishi Kogyo K.K.), 0.06 part of POISE 532A (manufactured by Kao Corp.), 1.87 parts of HYDRIN Z-7 (manufactured by Chukyo Oil & Fat Co., Ltd.) 1.25 parts of a 10% by mass polyvinyl alcohol (manufactured by Kuraray Co., Ltd. with a trade name of PVA 105) aqueous solution, and 0.39 part of a 2% by mass sodium dodecylsulfonate aqueous solution were mixed and finely dispersed with a dyno mill. The dispersion thus obtained is called a pigment solution. 4.4 parts of the pigment solution was added into 80 parts of the mother solution described above, and the mixed solution was agitated for at least 30 minutes. Thereafter, 2.8 parts of WETMASTER 500 (manufactured by Toho Chemical Industry Co., Ltd.) was added into the mixture, and the mixture was further agitated for at least 30 minutes to obtain a heat-sensitive protective layer coating solution (D).

(Coating)

The heat-sensitive recording layer coating solution (A) and the heat-sensitive protective layer coating solution (D) were coated with a wire bar in this order on a surface of a support for a photographic paper in which polyethylene was laminated on a high quality paper, followed by drying, to obtain a heat-sensitive recording material. Coating amounts of both coating solutions in terms of solids amount were 4.5 g and 1 g per m², respectively.

(Thermal Recording)

The thermal recording characteristics of the heat-sensitive recording material were evaluated by using a thermal head KST type (manufactured by KYOCERA CORP.) as recited in the following.

(1) The applied power to the thermal head and the pulse width were set so that the recording energy per unit area became 34 mJ/mm² and printing was conducted to record yellow image on the heat-sensitive recording material.

(2) The recording material was illuminated for 10 seconds by using an ultraviolet lamp that had a power of 40 W and emitted a light having the light-emission center wavelength of 420 nm to fix the image in non-printed portions. Regarding the color density of the yellow image, the optical reflection density in the colored portion was measured with a Macbeth densitometer (RD918 type). Results of the measurement are shown in Table 1 as a color density.

(3) Regrading the evaluation of the shelf life (raw preservability), after the obtained heat-sensitive recording material was stored in a thermohydrostat kept at 40° C. and 90% (RH) for 24 hours, the non-printed portions of the heat-senstive recording material was fixed and the optical reflection density in the background portion of the heat-sensitive recording material was measured. Results of the evaluation are shown in Table 1 as a fog density.

### Example 2

A heat-sensitive recording material was prepared in the same manner as that in Example 1 except that the isocyanate compound (2) described in Synthesis Example 2 was used instead of the isocyanate compound (1) described in Synthesis Example 1 as a capsule wall material in preparation of the microcapsule liquid in which the microcapsules included the diazo compound of Example 1.

The average capsule particle diameter was 0.50 μm.

### Example 3

A heat-sensitive recording material was prepared in the same manner as that in Example 1 except that the isocyanate compound (3) described in Synthesis Example 3 was used instead of the isocyanate compound (1) described in Synthesis Example 1 as a capsule wall material in preparation of the microcapsule liquid in which the microcapsules included the diazo compound of Example 1.

The average capsule particle diameter was 0.54 μm.

### Example 4

A heat-sensitive recording material was prepared in the same manner as that in Example 1 except that the isocyanate compound (4) described in Synthesis Example 4 was used instead of the isocyanate compound (1) described in Synthesis Example 1 as a capsule wall material in preparation of the microcapsule liquid in which the microcapsules include the diazo compound of Example 1.

The average capsule particle diameter was 0.56 μm.

Example 5

A coupler emulsified dispersion was prepared and a heat-sensitive recording material was obtained by the same method to that in Example 1 except that in preparation of the coupler emulsified dispersion of Example 1, 2.4 parts of 2,5-di-n-heptyloxyacetoanilide, 1.2 parts of triphenylguanidine, and 2.4 parts of 4,4′-(m-phenylenediisopropylidene) diphenol were dissolved into 8.0 parts of ethyl acetate, heated, and mixed uniformly. The coating amount of the coating solution in terms of solids amount was 3.2 g per m².

### Example 6

A heat-sensitive recording material was prepared by the same method as that in Example 1 except that as a capsule wall material in the preparation of the microcapsule liquid in which the microcapsules included the diazo compound of Example 1, the isocyanate compound (3) described in Synthesis Example 3 was used instead of the isocyanate compound (1) described in Synthesis Example 1 and as the coupler emulsified dispersion, the coupler emulsified dispersion employed in Example 5 was used.

### Example 7

A microcapsule liquid in which the microcapsules included a diazo compound was prepared in the same manner as in Example 1 except that 6.9 parts of a mixture obtained by mixing 4.5 parts of xylylenediisocyanate/trimethylolpropane adduct (in the form of a 75% by mass solution in ethyl acetate, manufactured by Mitsui Takeda Chemical Industries Co., Ltd. with a trade name of TAKENATE D110N) and 4.5 parts of a 30% by mass solution in ethyl acetate of a xylylenediisocyanate/bisphenol A adduct synthesized according to the method described in JP-A No. 07-088356, and 1.7 parts of the isocyanate compound (1′) described in Synthesis Example 1 were used as the capsule wall material in preparation of the microcapsule liquid in which the microcapsules included the diazo compound of Example 1.

The average particle diameter of the microcapsules was 0.45 μm.

A heat-sensitive recording material was obtained by the same method as that in Example 1 except that said microcapsule liquid in which the microcapsules included a diazo compound and the coupler emulsified dispersion used in Example 5 were used.

### Comparative Example 1

A microcapsule liquid in which the microcapsules included a diazo compound was prepared in the same manner as that in Example 1 except that 8.6 parts of a mixture obtained by mixing 4.5 parts of xylylenediisocyanate/trimethylolpropane adduct (in the form of a 75% by mass solution in ethyl acetate, manufactured by Mitsui Takeda Chemical Industries Co., Ltd. with a trade name of TAKENATE D110N) and 4.5 parts of a 30% by mass solution in ethyl acetate of an adduct of xylylenediisocyanate/bisphenol A synthesized according to the method described in JP-A No. 07088356 were used as the capsule wall material, and the isocyanate compound (1) described in Synthesis Example 1 was not used, in the preparation of the microcapsule liquid in which the microcapsules included a diazo compound of Example 1.

The average particle diameter of microcapsules was 1.0 μm. A heat-sensitive recording material was obtained by the same method as that in Example 1 except that thus obtained microcapsule liquid in which the microcapsules included a diazo compound, was used.

### Comparative Example 2

A heat-sensitive recording material was prepared in the same manner as that in Example 1 except that the microcapsule liquid in which the microcapsules included a diazo compound described in Comparative Example 1 and the coupler emulsified dispersion described in Example 5 were used.

The heat-sensitive recording materials (Examples 2 to 7 and Comparative Examples 1 and 2) were evaluated by the same manner as that in Example 1. The results of the evaluation are shown in Table 1.

TABLE 1

| | Color densities | Fog densities |
|---|---|---|
| Example 1 | 0.90 | 0.12 |
| Example 2 | 0.90 | 0.12 |
| Example 3 | 0.88 | 0.12 |
| Example 4 | 0.82 | 0.13 |
| Example 5 | 0.71 | 0.11 |
| Example 6 | 0.64 | 0.11 |
| Example 7 | 0.98 | 0.14 |
| Comparative | 0.61 | 0.13 |
| Example 1 | | |
| Comparative | 0.20 | 0.12 |
| Example 2 | | |

As is apparent from Table 1, it was found that the heat-sensitive recording materials of Examples 1 to 7 using the microcapsules of the invention showed similar fog density values to the fog density values in comparative examples, and showed higher color density values than the color density values in comparative examples.

### Example 8

(Preparation of Heat-Sensitive Recording Layer Coating Solution (B))

Preparation of Microcapsule liquid in which microcapsules Include Diazo Compound

2.8 parts of the following compound (B-1) having the maximum absorption wavelength for dissociation at 365 nm as a diazo compound, 2.8 parts of dibutyl sulfate and 0.56 part of 2,2-dimethoxy-1,2-diphenylethane-1-on (manufactured by Ciba-Geigy Corp. with a trade name of IRGACURE 651) were dissolved into 10.0 parts of ethyl acetate. 5.9 parts of isopropylbiphenyl, which is a solvent having a high boiling point, and 2.5 parts of tricresyl phosphate were further added to the solution. And the mixture was heated and mixed uniformly.

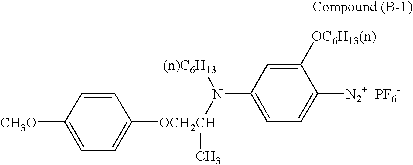

As a capsule wall material, 7.6 parts of xylylenediisocyanate/trimethylolpropane adduct (a 75% by mass solution in ethyl acetate manufactured by Mitsui Takeda Chemical Industries, Ltd. with a trade name TAKENATE D110N) was added into the mixture obtained above, and agitated uniformly. Separately, 64 parts of a 6% by mass gelatin (manufactured by Nippi Gelatin Industries, Ltd. with a trade name of MGP-9066) aqueous solution including 2.0 part of a 10% by mass aqueous solution of sodium docecylsulfonate was separately prepared. The mixed solution including the diazo compound was added to the gelatin solution, and emulsion dispersed by using a homegenizer.

20 parts of water was added into the emulsion. Then, the emulsion was made homogeneous, and allowed to react for 30 minutes at 40° C. with agitation. Then, the temperature of the emulsion was elevated to 60° C. and the capsule forming reaction was proceeded for 3 hours. Thereafter, the temperature of the emulsion was lowered to 35° C. 4.1 parts of ion exchange resin AMBERLITE IRA68 (manufactured by Organo Corporation) and 8.2 parts of ion exchange resin AMBERLITE IRC50 (manufactured by Organo Corporation) were added to the emulsion. The emulsion was further agitated for 1 hour. Thereafter, the ion exchange resin was filtrated out and the microcapsule liquid in which the microcapsules included a diazo compound was obtained. The average particle diameters of the obtained microcapsules was 0.64

Preparation of Coupler Emulsified Dispersion

As a coupler, 3.0 parts of the following compound (B-2), 8.0 parts of triphenylguanidine, 8.0 parts of 1,1-(p-hydroxyphenyl)-2-ethylhexane, 8.0 parts of 4.4°-(p-phenylenediisopropylidene)diphenyl, 2.0 parts of the following compound (B-3), and 2.0 parts of 1,1,3-tris(2-methyl-4-hydroxy-5-t-butylphenyl) butane, were dissolved into 10.5 parts of ethyl acetate. 0.48 part of tricresyl phosphate, which is a solvent having a high boiling point, 0.24 part of diethyl maleate, and 1.27 parts of PIONIN A41C (manufactured by Takemoto Oil & Fat Co., Ltd.) were further added to the solution. The mixture was heated and mixed uniformly. The mixture was added into 93 parts of an 8% by mass gelatin (manufactured by Nitta Gelatin Co., Ltd. with a trade name of #750 Gelatin) aqueous solution, and emulsion dispersed with a homogenizer. Residual ethyl acetate was evaporated off from the emulsion to obtain a coupler emulsified dispersion.

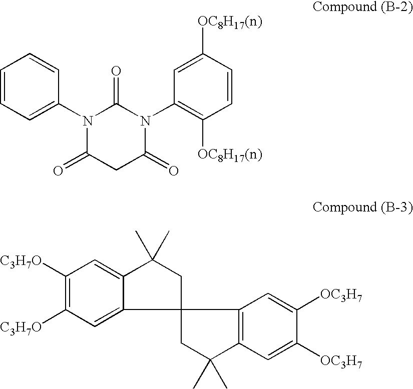

Preparation of Heat Sensitive Recording Layer Coating Solution (B)

The microcapsule liquid in which the microcapsules included the diazo compound and the coupler emulsified dispersion were mixed so that a mass ratio of the diazo compound/the coupler compound became 1.0/3.2 to obtain a heat-sensitive recording layer coating solution (B).

(Preparation of Heat-Sensitive Recording Layer Coating Solution (C))

Preparation of Electron-Donating Dye Precursor Capsule Emulsion

0.39 part of 3-(o-methyl-p-diethylaminophenyl)-3-(1′-ethyl-2-methylindole-3-yl) phthalide as an electron-donating dye precursor, 0.19 part of 2-hydroxy-4-methoxybenzophenone having the maximum absorption wavelength at 285 nm as an ultraviolet absorbent, and 0.29 part of 2,5-tert-octylhydroquinone, were dissolved into 0.93 part of ethyl acetate. Further, 0.54 part of phenethylcumene, which is a solvent having a high boiling point, was added into the solution. Then, the solution was heated and mixed uniformely to prepare an electron-donating dye precursor solution. Further, 1.0 part of xylilenediisocyanate/trimethylolpropane adduct (TAKENATE D110N) was added into the electron-donating dye precursor solution, and agitated uniformly. Separately, 36.4 parts of a 6% by mass gelatin (manufactured by Nippi Gelatin Industries, Ltd. with a trade name of MGP-9066) including 0.07 part of a 10% sodium dodecylsulfonate aqueous solution, was prepared. To this gelatiin solution, the electron-donating dye precursor solution was added, and emulsion dispersed with a homogenizer. The emulsified dispersion thus obtained is referred to as a primary emulsified dispersion.

Separately, 6.0 parts of 3-(o-methyl-p-diethylaminophenyl)-3-(1′-ethyl-2-methylindole-3-yl)phthalide, 3.0 parts of 2-hydroxy-4-methoxybenzophenone, and 4.4 parts of 2,5-tert-octylhydroquinone, were dissolved into 14.4 parts of ethyl acetate. Further, 8.4 parts of phenethylcumene, which is a solvent having a high boiling point, was added into the solution, and agitated uniformly. To this solution, 7.8 parts of TAKENATE D 110N recited previously and 5.9 parts of methylenediisocyanate (manufactured by Nippon Polyurethane Co., Ltd. with a trade name of MILLIONATE MR200), were added, and agitated uniformly. Thus obtained solution and 1.2 parts of a 10% sodium dodecylsulfonate aqueous solution, were added into the primary emulsified dispersion described above, and emulsion dispersed with a homogenizer. The emulsified dispersion thus obtained is referred to as a secondary emulsified dispersion. 60.0 parts of water and 0.4 part of diethylenetriamine were added into the secondary emulsified dispersion, and the dispersion was made homogenous. Thereafter, the emulsion was heated to 65° C. while being agitated and the capsule formation was proceeded for 3.5 hours to obtain an electron-donating dye precursor capsule emulsion. The average particle diameter of the microcapsules was 1.9 μm.

Preparation of Electron-Accepting Compound Dispersion

30 parts of bisphenol P, as an electron-accepting compound, was added into 82.5 parts of a 2.0% by mass gelatin (manufactured by Nippi Gelatin Industries, Ltd. with a trade name of MGP-9066) aqueous solution, and 7.5 parts of a 2% by mass sodium 2-ethylhexylsulfosuccinate aqueous solution was further added into the solution and the mixture thus obtained was dispersed with a ball mill for 24 hours to prepare a dispersion. 36.0 parts of a 15% by mass gelatin (Nitta Gelatin Co., Ltd. with a trade name of #750 Gelatin) aqueous solution was added into the dispersion. And the dispersion was agitated uniformly to obtain an electron-accepting compound dispersion. The average particle diameter of the electron-accepting compound in the dispersion was 0.5 μm.

Preparation of Coating Solution

The electron-donating dye precursor capsule emulsion, the electron-accepting compound dispersion, a 15% by mass gelatin (manufactured by Nitta Gelatin Co., Ltd. with a trade name of #750 Gelatin) aqueous solution, and a stilbene based fluorescent brightening agent (manufactured by Sumitomo Chemical Co., Ltd. with a trade name of WHITEX-BB) was mixed so that the ratio of the electron-donating dye precursor/the electron-accepting compound became 1/14, the ratio of the electron-donating dye precursor/#750 Gelatin was 1.1/1, and the ratio of the electron-donating dye precursor/the fluorescent brightening agent became 5.3/1 to prepare a coating solution.

(Preparation of Intermediate Layer Coating Solution (E))

8.2 parts of a 4% by mass boric acid aqueous solution, 1.2 parts of a 2% by mass sodium (4-nonylphenoxytrioxyethylene)butyl sulfonate, and 7.5 parts of a 2% by mass aqueous solution of the following compound (E-1) were added into a 14% by mass gelatin (manufactured by Nitta Gelatin Co., Ltd. with a trade name of #750 Gelatin) aqueous solution. The mixture was agitated uniformly to prepare an intermediate layer coating solution (E).

(CH₃CH₂SO₂CH₂CONHCH₂)₂ (E-1)

(Coating)

The heat-sensitive recording layer coating solution (C), the intermediate layer coating solution (E), the heat-sensitive recording layer coating solution (B), the intermediate layer coating solution (E), the heat-sensitive recording layer coating solution (A) described in Example 1, and the heat-sensitive protective layer coating solution (D) described in Example 1, were coated in this order with a wire bar on a surface of a support for a photographic paper in which polyethylene was laminated on a high quality paper, followed by drying, to obtain a multicolor heat-sensitive recording material. The coating amounts of the coating solutions in terms of solids amounts were 9 g, 3g, 8 g, 3 g, 4.5 g and 1 g per m², respectively.

(Thermal Recording)

The thermal recording characteristics of the multicolor heat-sensitive recording material was evaluated with a thermal head KST type (fabricated by KYOCERA CORP.) by the following way.

(1) The applied power to the thermal head and the pulse width were adjusted so that the recording energy per unit area became 35 mJ/mm² and the printing was conducted to record yellow image on the multicolor heat-sensitive recording material.

(2) The recording material was illuminated for 10 seconds by using ultraviolet lamp having the output power of 40 W and the light-emission center wavelength of 420 nm.

(3) The applied power to the thermal head and the pulse width were again adjusted so that the recording energy per unit area became 80 mJ/mm² and magenta image was recorded.

(4) The recording material was illuminated for 15 seconds by using an ultraviolet lamp having the output power of 40 W and the light-emission center wavelength of 365 nm.

(5) The applied power to the thermal head and the pulse width were again adjusted so that the recording energy per unit area became 140 mJ/mm² and cyan image was recorded.

As a result, in addition to color images in yellow, magenta and cyan, respectively, red color was developed in recorded portions where yellow recording and magenta recording overlapped, blue color was developed in recorded portions where magenta recording and cyan recording overlapped, green color was developed in recorded portions where yellow recording and cyan recording overlapped, and black color was developed in recorded portions where yellow recording, magenta recording, and cyan recording overlapped. A non-recorded portion developed gray white.

The optical reflection densities of the colored portions in yellow, magenta, and cyan were measured with a Macbeth RD918 type densitometer. Regarding the evaluation of shelf life (raw preservability), the obtained multicolor heat-sensitive recording material was stored in a thermohygrostat kept at 40° C. and 90%(RH) for 24 hours, the multicolor heat sensitive recording material was fixed, and the optical reflection density (background fog density) in the background portion was measured.

### Example 9

A multicolor heat-sensitive recording material was obtained in the same manner as that in Example 8 except that the microcapsule liquid in which the microcapsules included the diazo compound described in Example 3 was used as the microcapsule liquid in which the microcapsules included the diazo compound used in the heat-sensitive recording layer (A). Thus obtained heat-sensitive recording material was also evaluated in the same manner as that in Example 8. The results of the evaluation are shown in Table 2.

TABLE 2

| | | | | Background fog |
|---|---|---|---|---|
| | Color densities in printed portion | | | densities |
| | Yellow | Magenta | Cyan | (yellow) |
| Example 8 | 0.90 | 1.00 | 1.20 | 0.12 |
| Example 9 | 0.88 | 0.95 | 1.20 | 0.12 |

As is apparent from Table 2, the multicolor heat-sensitive recording materials of Examples 8 and 9 each using microcapsules of the invention showed high color densities. Also, the multicolor heat-sensitive recording materials of Example 8 and 9 showed fog densities similar to the densities of Comparative Examples 1 and 2.

### Synthesis Example 5

### Synthesis of Isocyanate Compound (1′)

An isocyanate compound (1′) was synthesized according to the following synthesis procedure.

75 parts of the polyether derivative (1′-2) described above as an example of the polyether derivative was dried by using a vacuum pump at the environmental temperature of 80° C. for 2 hours and thereafter, the temperature of the compound was lowered to room temperature, and, in a nitrogen stream, 125 parts of dry ethyl acetate and 100 parts of a polyfunctional isocyanate compound (a 75% by mass solution in ethyl acetate of a xylylenediisocyanate/trimethylolpropane adduct manufactured by Mitsui Takeda Chemical Industries Ltd. with a trade name of TAKENATE D110N) were added to the dried compound, followed by agitation at 50° C. for 3 hours. Thereby, a 50% isocyanate compound (1′) solution was obtained.

### Synthesis Example 6

### Synthesis of Isocyanate Compound (2′)

A 50% isocyanate compound (2′) solution was obtained in the same manner as that in Synthesis Example 5 except that the polyether derivative (1′-2) used in Synthesis Example 5 was replaced with the polyether derivative (1′-3) described above as an example of the polyether derivative.

### Synthesis Example 7

### Synthesis of Isocyanate Compound (3′)

A 50% isocyanate compound (3′) solution was obtained in the same manner as that in Synthesis Example 5 except that the polyether derivative (1′-2) used in Example synthesis 5 was replaced with the polyether derivative (1′-1) described above as an example of the polyether derivative.

### Synthesis Example 8

### Synthesis of Isocyanate Compound (4′)

A 50% isocyanate compound (4′) solution was obtained in the same manner as that in Synthesis Example 5 except that the polyether derivative (1′-2) used in Synthesis Example 5 was replaced with the polyether derivative (3′-1) described above as an example of the polyether derivative.

### Example 10

(I) Preparation of Heat-Sensitive Recording Layer (A′) Coating Solution

Preparation of Capsule Liquid in Which Microcapsules Include Diazonium Salt

3.5 parts of the following compound (A′-1) having the maximum absorption wavelength at 420 nm as a diazonium compound and 0.9 part of the following compound (A′-2) were dissolved into 16.4 parts of ethyl acetate. 7.3 parts of isopropylbiphenyl as a solvent having a high boiling point and 2.5 parts of diphenyl phthalate were further added into the solution, heated and mixed uniformly.

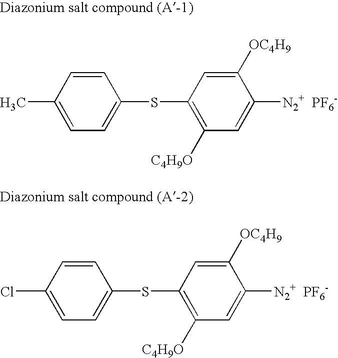

As capsule wall materials, 6.9 parts of a mixture obtained by mixing 4.5 parts of a xylylenediisocyanate/trimethylolpropane adduct (in the form of 75% solution in ethyl acetate manufactured by Mitsui Takeda Chemical Industries Ltd. with a trade name of TAKENATE D110N) and 4.5 parts of a 30% solution in ethyl acetate of a xylylenediisocyanate/bisphenol A adduct synthesized according to a method described in JP-A No. 7-88356, and 1.7 parts of the isocyanate compound (1′) obtained in Synthesis Example 5, were added into the mixed solution described above. And the mixture was agitated uniformly.

77 parts of an 8% by mass phthalated gelatin aqueous solution including 0.36 part of SCRAPH AG-8 (manufactured by Nippon Fine Chemical Co., Ltd.) was separately prepared. To the gelatin solution, the mixed solution of the diazonium salt compound and the isocyanate compound were added, and emulsion dispersed with a homegenizer.

20 parts of water was added into the emulsion obtained. Then, the emulsion was made homogenous, and a capsule forming reaction was proceeded for 3 hours while the emulsion was agitated at 40° C. Thereafter, the temperature of the emulsion was lowered to 35° C. 4.1 parts of ion exchange resin AMBERLITE IRA68 (manufactured by Organo Corporation) and 8.2 parts of ion exchange resin AMBERLITE IRC50 (manufactured by Organo Corporation) were added into the emulsion, and the obtained emulsion was further agitated for 1 hour. Thereafter, the ion exchange resin was filtrated out and the concentration of solids in the microcapsule liquid was adjusted to 20.0%. Thereby, the microcapsule liquid in which the microcapsules included a diazonium salt compound, was obtained. The particle diameters of the obtained microcapsules were measured with a particle diameter distribution measuring instrument (fabricated by Horiba, Ltd., with a trade name of LA-700), and the median diameter of the particles was found to be 0.79 μm.

(2) Preparation of Coupler Emulsified Dispersion

As coupler compounds, 2.4 parts of 2,5-di-n-heptyloxyacetoanilide, 2.5 parts of triphenylguanidine, furthermore, 3.3 parts of 4-(2-ethylhexyloxy)phenylsulfonamide, 1.7 parts of 4-n-pentyloxyphenylsulfonamide, and 5.0 parts of 4,4′-(m-phenylenediisopropylidene)diphenol were dissolved into 8.0 parts of ethyl acetate. 1.0 part of PIONIN A41C (manufactured by Takemoto Oil & Fat Co., Ltd.) was added into the solution, and the solution was heated and mixed uniformly. The mixture was added into 75.0 parts of a 10% gelatin (manufactured by Nitta Gelatin Co., Ltd. with a trade name of #750 Gelatin) aqueous solution that had been separately prepared, followed by emulsion dispersing at 40° C. with a homogenizer. Residual ethyl acetate was evaporated off from the emulsified dispersion to adjust the concentration of solids to 26.5% by mass.

Then, 9 parts of a SBR latex solution obtained by adjusting the concentration of SBR latex to 26.5% (using a 48% solution, manufactured by Sumika ABS Latex K.K. with a trade name SN-₃O₇) was added into 100 parts of the coupler emulsified dispersion described above, and agitated uniformly to obtain a coupler emulsified dispersion.

(3) Preparation of Heat Sensitive Recording Layer Coating Solution (A′)

The microcapsule liquid in which the microcapsules included a diazonium compound and the coupler emulsified dispersion, described above, were mixed together so that the mass ratio of the diazo compound/ the coupler compound became 1.0/3.2 to obtain a heat-sensitive recording layer coating solution (A′).

(II) Preparation of Heat-Sensitive Protective Layer Coating Solution (D′)

2.0 parts of a 20.5% zinc stearate dispersion (manufactured by Chukyo Oil & Fat Co., Ltd. with a trade name HYDRIN F115) was added into 61 parts of a 5.0% itaconic acid modified polyvinyl alcohol (manufactured by Kuraray Co., Ltd. with a trade name of KL-318) aqueous solution. 8.4 parts of a 2% aqueous solution of the following compound (D-1), 8.0 parts of a fluorine type releasing agent (manufactured by DAIKIN INDUSTRIES LTD. with a trade name of ME-313), and 0.5 part of flour starch (manufactured by Kagoshima Denpun K.K. with a trade name of KF-4) were further added to the mixture, and agitated uniformly. The homogeneous mixture thus obtained is called a mother solution.

C₁₂H₂₅O—(C₂H₄O)₁₀—H Compound (D′-1)

Separately, 12.5 parts of an ion-exchanged, 20% aqueous solution of KAOGLOSS (manufactured by Shiraishi Kogyo K.K.), 0.06 part of POISE 532A (manufactured by Kao Corp.), 1.87 parts of HYDRIN Z-7 (manufactured by Chukyo Oil & Fat Co., Ltd.) 1.25 parts of a 10% polyvinyl alcohol (manufactured by Kuraray Co., Ltd. with a trade name of PVA 105) aqueous solution, and 0.39 part of a 2% sodium dodecylsulfonate aqueous solution, were mixed and finely dispersed with a dyno mill. The dispersion thus obtained is called a pigment solution. 4.4 parts of the pigment solution was added to 80 parts of the mother solution and agitated for at least 30 minutes. Thereafter, 2.8 parts of WETMASTER 500 (manufactured by Toho Chemical Industry Co., Ltd.) was added into the mixture and the mixture was further agitated for at least 30 minutes to obtain a heat-sensitive protective layer coating solution (D′).

(III) Preparation of Heat-Sensitive Recording Material

The heat-sensitive recording layer coating solution (A′) and the heat-sensitive protective layer coating solution (D′) were coated in this order with a wire bar on a surface of a support for a photographic paper obtained by laminating polyethylene on a high quality paper, followed by drying, to obtain a heat-sensitive recording material. The coating amounts of both coating solutions in terms of solids amounts were 4.5 g and 1.0 g per m², respectively.

(IV) Thermal Recording and Evaluation

The thermal recording characteristics of the heat-sensitive recording material was evaluated by using a thermal head KST type (manufactured by KYOCERA CORP.) according to the following way.

(1) The applied power to the thermal head and the pulse width were set so that the recording energy per unit area became 34 mJ/mm² and yellow image was recorded on the heat-sensitive recording material.

(2) The recording material was illuminated for 10 seconds by using an ultraviolet lamp that had the output power of 40 W and the light-emission center wavelength of 420 nm to fix images in a non-printed portions. Regarding the color density of the yellow image, the optical reflection density in the colored portion was measured with a Macbeth densitometer (RD9 18 type). The results of measurement are shown in Table 3 as color densities.

(3) Regarding the evaluation on a shelf life (raw preservability), the obtained heat-sensitive recording material was stored in a thermohygrostat kept at 40° C. and 90%(RH) for 24 hours, the non-printed portions of the heat-sensitive recording material were fixed, and the optical reflection density in the background portion of the obtained heat-sensitive recording material was measured. The results of the evaluation are shown in Table 3 as fog densities.

### Example 11

A heat-sensitive recording material was prepared in the same manner as that in Example 10 except that the isocyanate compound (2′) described in Synthesis Example 6 was used instead of the isocyanate compound (1′) described in Synthesis Example 5 and used as a capsule wall material in preparation of the microcapsule liquid of Example 10 in which the microcapsules included a diazonium salt compound. The average particle diameter of microcapsules was 0.9 μm.

### Example 12

A heat-sensitive recording material was prepared in the same manner as that in Example 10 except that the isocyanate compound (3′) obtained by Synthesis Example 7 was used instead of the isocyanate compound (1′) described in Synthesis Example 5 and used as a capsule wall material in preparation of the microcapsule liquid of Example 10 in which the microcapsules included a diazonium salt compound.

The average particle diameter of microcapsules was 0.8 μm.

### Example 13

A heat-sensitive recording material was prepared in the same manner as in Example 10 except that the isocyanate compound (4′) described in Synthesis Example 8 was used instead of the isocyanate compound (1′) described in Synthesis Example 5 and used as a capsule wall material in preparation of the microcapsule liquid of Example 10 in which the microcapsules included a diazonium salt compound. The average microcapsule particle diameter was 0.9 μm.

### Example 14

A heat-sensitive recording material of Example 14 was obtained by the same method as that in Example 10 except that, in preparation of the coupler emulsified dispersion, 2.4 parts of 2,5-di-n-heptyloxyacetoanilide, 1.2 parts of triphenylguanidine and 2.4 parts of 4,4′-(m-phenylenediisopropylidene)diphenol were used as the coupler compounds. Herein, the coating amount of the heat-sensitive recording layer was 3.2 g per m² in terms of solids amount.

### Example 15

A heat-sensitive recording material of Example 15 was obtained in the same manner as that in Example 10 except that, as the capsule wall materials used in the preparation of the microcapsule liquid in which the microcapsules included the diazonium salt, the isocyanate compound (3′) obtained in Synthesis Example 7 was used instead of the isocyanate compound (1′) of Synthesis Example 5 and the coupler emulsified dispersion of Example 14 was used as the coupler emulsified dispersion. The average particle diameter of microcapsules was 0.7 μm.

### Example 16

A microcapsule liquid in which the microcapsules included a diazonium salt was obtained in the same manner as that in Example 10 except that as the capsule wall materials used in the preparation of the microcapsule liquid in which the microcapsules included a diazonium salt, 4.3 parts of a mixture obtained by mixing 4.5 parts of xylylenediisocyanate/trimethylolpropane adduct (in the form of 75% by mass solution in ethyl acetate, with a trade name of TAKENATE D110N) and 4.5 parts of a 30% solution in ethyl acetate of a xylylenediisocyanate/bisphenol A adduct synthesized according to the method described in JP-A No. 07-088356, and 4.3 parts of the isocyanate compound (1′) described in Synthesis Example 5, were used. The average particle diameter of microcapsules was 0.7 μm. A heat-sensitive recording material of Example 16 was obtained by the same method as that in Example 10 except that thus obtained microcapsule liquid in which the microcapsules included a dizaonium compound and the coupler emulsified dispersion used in Example 14, were used.

### Comparative Example 3

A microcapsule liquid in which the microcapsules included a diazonium salt, was obtained in the same manner as in Example 10 except that as the capsule wall materials used in the preparation of the microcapsule liquid in which the microcapsules included a diazonium salt, 8.6 parts of a mixture obtained by mixing 4.5 parts of xylylenediisocyanate/trimethylolpropane adduct (in the form of 75% by mass solution in ethyl acetate, with a trade name of TAKENATE D110N) and 4.5 parts of a 30% solution in ethyl acetate of xylylenediisocyanate/bisphenol A adduct synthesized according to the method described in JP-A No. 07-088356, was used and the isocyanate compound (1′) described in Synthesis Example 5 was not used. The average particle diameter of microcapsules was 1.0 μm. Using thus obtained microcapsule liquid in which the microcapsules included a dizaonium salt, the heat-sensitive recording material of Comparative Example 3 was obtained by the same method as that in Example 10.

### Comparative Example 4

A heat-sensitive recording material of Comparative Example 4 was obtained in the same manner as in Example 10 except that the microcapsule liquid described in Comparative Example 3 in which the microcapsules included a diazonium salt and the coupler dispersion described in Example 14, were used.

Images were also recorded thermally on the heat-sensitive recording materials (Examples 11 to 16 and Comparative Examples 3 and 4) obtained as described above in the same manner as that in Example 10. And the color density and the optical density in non-color developed portions on each of the heat-sensitive recording materials were measured. The results of the measurement are shown in Table 3.

TABLE 3

| Heat-sensitive | | |
|---|---|---|
| materials | Color densities | Fog densities |
| Example 10 | 0.91 | 0.13 |
| Example 11 | 0.90 | 0.12 |
| Example 12 | 0.89 | 0.12 |
| Example 13 | 0.82 | 0.13 |
| Example 14 | 0.71 | 0.12 |
| Example 15 | 0.64 | 0.12 |
| Example 16 | 0.85 | 0.12 |
| Comparative | 0.61 | 0.13 |
| Example 3 | | |
| Comparative | 0.20 | 0.12 |
| Example 4 | | |

As is apparent from Table 3, the heat-sensitive recording materials of the invention including microcapsules each produced using the isocyanate compound, as a capsule wall material, including a reaction product between a polyfunctional isocyanate compound and a polyether derivative represented by the general formula (1′) showed higher color densities in the image portions and lower fog densities in the background than respective densities of the heat-sensitive recording materials of the comparative examples that did not include the reaction product.

### Example 17

(V) Preparation of Heat-Sensitive Recording Layer Coating Solution (B′)

(1) Preparation of Microcapsule Liquid in Which Microcapsules Include Diazonium Salt

2.8 parts of the following compound (B′-1) having the maximum absorption wavelength for dissociation at 365 nm as a diazonium salt compound, 2.8 parts of dibutyl sulfate and 0.56 part of 2,2-dimethoxy-1,2-diphenylethane-1-on (manufactured by Ciba-Geigy Corp. with a trade name of IRGACURE 651), were dissolved into 10.0 parts of ethyl acetate. To the solution, 5.9 parts of isopropylbiphenyl, which is a solvent having a high boiling point, and 2.5 parts of tricresyl phosphate, were added. The mixture was heated and mixed uniformly.

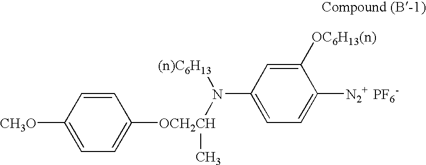

As a capsule wall material, 7.6 parts of xylylenediisocyanate/trimethylolpropane adduct (a 75% by mass solution in ethyl acetate manufactured by Mitsui Takeda Chemical Industries, Ltd. with a trade name TAKENATE D110N) was added to the mixture, and agitated uniformely.

64 parts of a 6% gelatin (manufactured by Nippi Gelatin Industries, Ltd. with a trade name of MGP-9066) aqueous solution including 2.0 part of a 10% aqueous solution of sodium docecylsulfonate, was separately prepared. To this gelatin solution, the above mixed solution of the diazonium salt compound and the isocyanate compound was added, followed by emulsion dispersing with a homegenizer.

20 parts of water was added into the obtained emulsion. The emulsion was made homogeneous and allowed to react for 30 minutes at 40° C. while the emulsion was agitated. Then, the temperature of the emulsion was raised to 60° C. and a capsule forming reaction was proceeded for 3 hours. Thereafter, the temperature of the emulsion was lowered to 35° C. To the emulsion, 4.1 parts of ion exchange resin AMBERLITE IRA68 (manufactured by Organo Corporation) and 8.2 parts of ion exchange resin AMBERLITE IRC50 (manufactured by Organo Corporation) were added and agitated for 1 hour. Thereafter, the ion exchange resin was filtrated out and the capsule liquid in which the microcapsules included a diazonium salt compound was obtained. The average particle diameters of the obtained microcapsules was 0.64 μm.

(2) Preparation of Coupler Emulsified Dispersion

As coupler compounds, 3.0 parts of the following compound (B′-2), 8.0 parts of triphenylguanidine, 8.0 parts of 1,1-(p-hydroxyphenyl)-2-ethylhexane, 8.0 parts of 4,4′-(p-phenylenediisopropylidene)diphenyl, 2.0 parts of the following compound (B′-3), and 2.0 parts of 1,1,3-tris(2-methyl-4-hydroxy-5-t-butylphenyl), were dissolved into 10.5 parts of ethyl acetate. 0.48 part of tricresyl phosphate, which is a solvent having a high boiling point, 0.24 part of diethyl maleate, and 1.27 parts of PIONIN A41C (manufactured by Takemoto Oil & Fat Co., Ltd.), were further added to the solution. The mixture was heated and mixed uniformly. The mixture was added into 93 parts of an 8% gelatin (manufactured by Nitta Gelatin Co., Ltd. with a trade name of #750 Gelatin) aqueous solution, followed by emulsion dispersing with a homogenizer. Residual ethyl acetate was evaporated off from the emulsified dispersion to obtain a desired coupler emulsified dispersion.

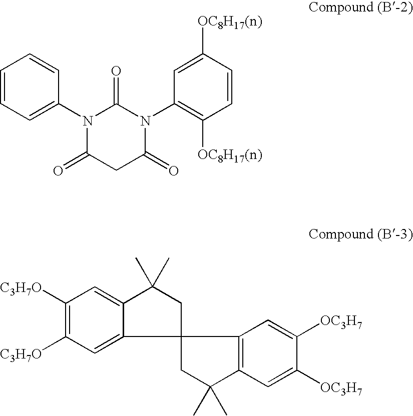

(3) Preparation of Heat-Sensitive Recording Layer Coating Solution (B′)

The microcapsule liquid in which the microcapsules included the diazonium salt compound, and the coupler emulsified dispersion were mixed together so that the mass ratio of the diazo compound/the coupler compound became 1.0/3.2. Thereby, a heat-sensitive recording layer coating solution (B′) was obtained.

(VI) Preparation of Heat-Sensitive Recording Layer Coating Solution (C′))

(1) Preparation of Capsule liquid Including Electron-Donating Dye Precursor

0.39 part of 3-(o-methyl-p-diethylaminophenyl)-3-(1′-ethyl-2-methylindole-3-yl) phthalide as an electron-donating dye precursor, 0.19 part of 2-hydroxy-4-methoxybenzophenone having the maximum absorption wavelength at 285 nm as an ultraviolet absorbent and 0.29 part of 2,5-tert-octylhydroquinone were dissolved into 0.93 part of ethyl acetate were. 0.54 part of phenethylcumene, which is a solvent having a high boiling point, was further added to the solution, and the solution was heated and mixed uniformly.

1.0 part of xylylenediisocyanate/trimethylolpropane adduct (TAKENATE D110N) was further added to the mixed solution. The mixture was agitated uniformly. Separately, 36.4 parts of a 6% gelatin (manufactured by Nippi Gelatin Industries, Ltd. with a trade name of MGP-9066) aqueous solution including 0.07 part of a 10% sodium dodecyl sulfonate aqueous solution, was prepared. The mixed solution of the electron-donating dye precursor and the isocyanate compound was added to the gelatin solution, and emulsion dispersed with a homogenizer. The emulsified dispersion thus obtained is referred to as a primary emulsified dispersion.

Separately, 6.0 parts of 3-(o-methyl-p-diethylaminophenyl) -(1′-ethyl-2-methylindole-3-yl)phthalide, 3.0 parts of 2-hydroxy-4-methoxybenzophenone and 4.4 parts of 2,5-tert-octylhydroquinone, were dissolved into 14.4 parts of ethyl acetate. 8.4 parts of phenethylcumene, which is a solvent having a high boiling point, were further added into the solution. The solution was agitated uniformly. To the solution, 7.8 parts of aforementioned TAKENATE D110N and 5.9 parts of methylenediisocyanate (manufactured by Nippon Polyurethane Co., Ltd. with a trade name of MILLIONATE MR200), were added and agitated uniformly.

Thus obtained solution and 1.2 parts of a 10% sodium dodecyl sulfonate aqueous solution were added to the primary emulsified dispersion described above and emulsion dispersed with a homogenizer. The emulsified dispersion thus obtained is referred to as a secondary emulsified dispersion. 60.0 parts of water and 0.4 part of diethylenetriamine were added to the secondary emulsified dispersion, followed by homogenization. Thereafter, the emulsion was heated to 65° C. while being agitated. The capsule formation was proceeded for 3.5 hours to obtain a microcapsule liquid in which the microcapsules included an electron-donating dye precursor. The average particle diameter of the microcapsules was 1.9 μm.

(2) Preparation of Electron-Accepting Compound Dispersion

30 parts of bisphenol P, as an electron-accepting compound, was added into 82.5 parts of a 2.0% gelatin (manufactured by Nippi Gelatin Industries, Ltd. with a trade name of MGP-9066) aqueous solution, 7.5 parts of a 2% by mass sodium 2-ethylhexylsulfosuccinate aqueous solution was further added into the aqueous solution and the mixture thus obtained was dispersed with a ball mill for 24 hours to prepare a dispersion. 36.0 parts of a 15% gelatin (Nitta Gelatin Co., Ltd. with a trade name of #750 Gelatin) aqueous solution was added to the dispersion. The dispersion was agitated uniformly to obtain an electron-accepting compound dispersion. The average particle diameter of the electron-accepting compound in the dispersion was 0.5 μm.

(3) Preparation of Heat-Sensitive Recording Layer Coating Solution (C′)

The microcapsule liquid in which the microcapsules included an electron-donating dye precursor, the electron-accepting compound dispersion, a 15% gelatin (manufactured by Nitta Gelatin Co., Ltd. with a trade name of #750 Gelatin) aqueous solution, and a stilbene based fluorescent brightening agent (manufactured by Sumitomo Chemical Co., Ltd. with a trade name of Whitex-BB), were prepared so that the mass ratio of the electron-donating dye precursor/the electron-accepting compound became 1/14, the mass ratio of the electro-donating dye precursor/#750 Gelatin became 1.1/1 and the mass ratio of the electron-donating dye precursor/the fluorescent brightening agent became 5.3/1. Thereby, a heat-sensitive recording layer (C′) coating solution was prepared.

(VII) Preparation of Intermediate Layer Coating Solution (E′))

8.2 parts of a 4% boric acid aqueous solution, 1.2 parts of a 2% sodium (4-nonylphenoxytrioxyethylene)butyl sulfonate, and 7.5 parts of a 2% aqueous solution of the following compound (E′-1), were added to a 14% gelatin (manufactured by Nitta Gelatin Co., Ltd. with a trade name of #750 Gelatin) aqueous solution. The mixture was agitated uniformly to prepare an intermediate layer coating solution (E′).

(CH₃CH₂SO₂CH₂CONHCH₂)₂— compound (E′-1)

(VIII) Preparation of Multicolor Heat-Sensitive Recording Material

The heat-sensitive recording layer coating solution (C′), the intermediate layer coating solution (E′), the heat-sensitive recording layer coating solution (B′), the intermediate layer coating solution (E′), the heat-sensitive recording layer coating solution (A′) described in Example 10, and the protective layer coating solution (D′), were coated in this order with a wire bar on a surface of a support for a photographic paper obtained by laminating polyethylene on a high quality paper, followed by drying, to obtain a multicolor heat-sensitive recording material. The coating amounts of the coating solutions in terms of solids amounts were 9.0 g, 3.0 g, 8.0 g, 3.0 g, 4.5 g, and 1.0 g per m², respectively.

(IX) Thermal Recording and Evaluation

The thermal recording characteristics of the multicolor heat-sensitive recording material were evaluated by using a thermal head KST type fabricated by KYOCERA CORP. according to the following way. The results are shown in Table 4.

(1) The applied power to the thermal head and the pulse width were adjusted so that the recording energy per unit area became 35 mJ/mm² and the printing was conducted to record yellow image on the multicolor heat-sensitive recording material.

(2) The recording material was illuminated for 10 seconds by using an ultraviolet lamp having the output power of 40 W and the light-emission center wavelength of 420 nm.

(3) The applied power to the thermal head and the pulse width were again adjusted so that the recording energy per unit area became 80 mJ/mm², and the printing was conducted to record magenta image.

(4) The recording material was illuminated for 15 seconds by using an ultraviolet lamp having the output power of 40 W and the light-emission center wavelength of 365 nm.

(5) The applied power to the thermal head and the pulse width were again adjusted so that the recording energy per unit area became 140 mJ/mm² and the printing was conducted to record cyan image.

As a result, in addition to respective color images in yellow, magenta and cyan, a recorded portion in which yellow recording and magenta recording overlap developed red, a recorded portion in which magenta recording and cyan recording overlap developed blue and a recorded portion in which yellow recording and cyan recording overlap developed green. Besides, a recorded portion in which yellow recording, magenta recording, and cyan recording overlap developed black. A non-recorded portion developed gray white. The optical reflection densities of the color developed portions in yellow, magenta and cyan were measured with a Macbeth RD918 type densiometer. Regarding the evaluation of shelf life (raw preservability), the heat-sensitive recording material was stored in a thermohygrostat kept at 40° C. and 90%(RH) for 24 hours, the heat-sensitive recording material was fixed, and the optical reflection densities in the background portion of the heat-sensitive recording material was measured.

### Example 18

A multicolor heat-sensitive recording material was obtained in the same manner as that in Example 17 except that the microcapsule liquid described in Example 12 in which the microcapsules included the diazonium salt compound, was used as the microcapsule liquid used in the heat-sensitive color developing layer (A′) in which the microcapsules included the diazonium salt compound. Using the heat-sensitive recording material thus obtained, thermal recording and evaluation were performed in the same similar manner as that in Example 17, and the color density and the optical density in a non-printed portion were measured. The results are shown in Table 4.

TABLE 4

| Heat- | | | | Background |
|---|---|---|---|---|
| sensitive | Color densities in printed portions | | | fog densities |
| materials | Yellow | Magenta | Cyan | (yellow) |
| Example 17 | 0.91 | 1.00 | 1.20 | 0.12 |
| Example 18 | 0.89 | 0.95 | 1.20 | 0.12 |

As is apparent from Table 4, a multicolor heat-sensitive recording material of the invention including microcapsules produced by using the isocyanate compound, as a capsule wall agent, obtained as a reaction product of the polyfunctional isocyanate compound with the polyether derivative represented by the general formula (1′) had high color density in respective colored portions in yellow, magenta and cyan, and low fog density in the background portion.

According to the invention, there can be obtained microcapsules using an isocyanate that reduces the environmental load and can be synthesized with a good energy efficiency. The microcapsule of the invention has execellent characteristics such as high heat sensitivity, high color developability by contact with a coupler or a color developing agent, and excellent raw perservability (a long raw shelf life) in a case where a diazo compound is used as a core material. The microcapsule of the invention has a sufficient color developability with a reduced content of or without using a heat sensitizer. Therefore, in a case where the microcapsules of the invention are used in a heat-sensitive recording layer of a heat-sensitive recording material, the heat-sensitive recording material has high sensitivity and color developing property, and in a case where a diazo compound is used as a core material, it is possible to obtain a heat-sensitive recording material excellent in raw preservability. Furthermore, by using microcapsules of the invention in a heat-sensitive recording layer, it is also possible to obtain a multicolor heat-sensitive recording material having high sensitivity, excellent color reproducibility, and excellent raw preservability.

What is claimed is:

1. A microcapsule produced using at least an isocyanate compound, wherein the isocyanate compound is a reaction product of (A) a compound having at least two isocyanate groups in a molecule with (B) a polyether derivative having two or more functional groups each having an active hydrogen atom at one terminal thereof and a polyether moiety that has a degree of polymerization in the range of 10 to 500.

2. A microcapsule according to claim 1, wherein the polyether derivative is represented by the following general formula (1):
R—O—(L-O)_{N}—X-A-(NH₂)ₘ General formula (1)
wherein X represents a single bond, —CO— or —SO₂—; A represents an arenetriyl or arenetetrayl group, or an alkanetriyl or alkanetetrayl group based on the selection of m selected from 2 or 3; L represents an alkylene group; R represents an alkyl group, an aryl group, or an acyl group; and n is an integer from 10 to 500.

3. A microcapsule according to claim 2, wherein A in general formula (1) is an arenetriyl group having two NH₂ groups as substituents and having 6 to 30 carbon atoms in total, or an arenetetrayl group having three NH₂ groups as substituents and having 6 to 30 carbon atoms in total.

4. A microcapsule according to claim 2, wherein A in general formula (1) is an alkanetriyl group having two NH₂ groups as substituents and having 1 to 30 carbon atoms in total, or an alkanetetrayl group having three NH₂ groups as substituents and having 1 to 30 carbon atoms in total.

5. A microcapsule according to claim 1, comprising a diazo compound or an electron-donating dye precursor.

6. A microcapsule according to claim 2, comprising a diazo compound or an electron-donating dye precursor.

7. A heat-sensitive recording material comprising a heat-sensitive recording layer formed on a support, the heat-sensitive recording layer including (i) a coupler and a microcapsule containing a diazo compound, or (ii) a color developing agent and a microcapsule containing an electron-donating dye precursor,
wherein the microcapsule containing the diazo compound or the electron-donating dye precursor is produced using at least an isocyanate compound that is a reaction product of (A) a compound having at least two isocyanate groups in a molecule with (B) a polyether derivative having two or more functional groups each having an active hydrogen atom at one terminal thereof and a polyether moiety that has a degree of polymerization in the range of 10 to 500.

8. A heat-sensitive recording material according to claim 7, wherein the polyether derivative is represented by the following general formula (1):
R—O—(L-O)_{N}—X-A-(NH₂)ₘ General formula (1)
wherein X represents a single bond, —CO— or —SO₂—; A represents an arenetriyl or arenetetrayl group, or an alkanetriyl or alkanetetrayl group based on the selection of m selected from 2 or 3; L represents an alkylene group; R represents an alkyl group, an aryl group, or an acyl group; and n is an integer of 10 to 500.

9. A multicolor heat-sensitive recording material comprising a heat-sensitive recording layer that develops cyan, a heat-sensitive recording layer that develops magenta and a heat-sensitive recording layer that develops yellow, formed on a support, each of the heat-sensitive recording layers including (i) a coupler and a microcapsule containing a diazo compound; or (ii) a color developing agent and a microcapsule containing an electron-donating dye precursor,
wherein at least one kind of microcapsule containing the diazo compoud or the electron-donating dye precursor is produced using at least an isocyanate compound which is a reaction product of (A) a compound having at least two isocyanate groups in a molecule with (B) a polyether derivative having two or more functional groups each having an active hydrogen atom at one terminal thereof, and a polyether moiety that has a degree of polymerization in the range of 10 to 500.

10. A multicolor heat-sensitive recording material according to claim 9, wherein the polyether derivative is represented by the following general formula (1):
R—O—(L-O)ₙ—X-A-(NH₂)ₘ General formula (1)
wherein X represents a single bond, —CO— or —SO₂—; A represents an arenetriyl or arenetetrayl group, or an alkanetriyl or alkanetetrayl group based on the selection of m selected from 2 or 3; L represents an alkylene group; R represents an alkyl group, an aryl, or an acyl group; and n is an integer of 10 to 500.

11. A microcapsule having a polyurea or a polyurethane/urea wall, obtained by polymerization of an isocyanate compound with a compound having an active hydrogen atom, wherein at least one kind of the isocyanate compound is a reaction product of (1) a isocyanate compound having at least two isocyanate groups with (2) a polyether derivative having a terminal amino group represented by the following general formula (1′):
R—O(L-O)ₙ(X)ₘ-A-NH₂ General formula (1′)
wherein X represents —CO— or —SO₂—; A represents an arylene group, or an alkylene group; L represents an alkylene group; R represents an alkyl group, an aryl group, or an acyl group; m is an integer of 0 or 1; and n is an average additional molar number of a polyether group in the range of 10 to 500.

12. A microcapsule according to claim 11, wherein in general formula (1′), A represents an arylene group, and m is an integer of 1.

13. A microcapsule according to claim 11, wherein in general formula (1′), a group represented by —(X)ₘ-A-NH₂ is selected from the group consisting of an aminoethyl group, an aminopropyl group, a 4-aminobenzoyl group, a 3-aminobenzoyl group, a 4-aminobenzensulfonyl group, an aminoacetyl group, and an aminoethylsulfonyl group.

14. A microcapsule according to claim 11, wherein in general formula (1′), a moiety represented by -(L-O)ₙ— is selected from the group consisting of polyethylene oxide, polypropylene oxide, polytetramethylene oxide, polystyrene oxide, polycyclohexylene oxide, a polyethylene oxide-polypropylene oxide-block copolymer, and a polyethylene oxide-polypropylene oxide random copolymer.

15. A microcapsule according to claim 11, comprising a diazo compound or an electron-donating dye precursor.

16. A microcapsule according to claim 12, comprising a diazo compound or an electron-donating dye precursor.

17. A heat-sensitive recording material comprising a support and a heat-sensitive recording layer including (1) a microcapsule containing a diazo compound, and a coupler; or (2) a microcapsule containing an electron-donating dye precursor, and a color developing agent; the heat-sensitive recording layer being formed on the support, wherein the microcapsule contains a diazo compound or an electron-donating dye precursor, has a polyurea or a polyurethane/urea wall and is produced by polymerization of an isocyanate compound with a compound having an active hydrogen atom, and at least one kind of the isocyanate compound that is used is a reaction product of (1) an isocyanate compound having at least two isocyanate groups with (2) a polyether derivative having a terminal amino group represented by the following general formula (1′):
R—O(L-O)(X)ₘ-A-NH₂ General formula (1 ′)
wherein X represents —CO— or —SO₂—; A represents an arylene group, or an alkylene group; L represents an alkylene group; R represents an alkyl group, an aryl group, or an acyl group; m is an integer of 0 or 1; and n is an average additional molar number of a polyether group in the range of 10 to 500.

18. A heat-sensitive recording material according to claim 17, wherein in general formula (1′), A represents an arylene group, and m is an integer of 1.

19. A multicolor heat-sensitive recording material comprising a support and heat-sensitive recording layers in cyan, magenta and yellow, respectively, formed on the support, each of the heat-sensitive recording layers including (1) a microcapsule containing a diazo compound, and a coupler; or (2) a microcapsule containing an electron-donating dye precursor, and a color developing agent,
wherein at least one kind of the microcapsule contains a diazo compound or an electron-donating dye precursor, has a polyurea or a polyurethane/urea wall, and is produced by polymerization of an isocyanate compound with a compound having an active hydrogen atom, and at least one kind of the isocyanate compound that is used is a reaction product of (1) an isocyanate compound having at least two isocyanate groups with (2) a polyether derivative having a terminal amino group represented by the following general formula (1′):
R—O(L-O)_{N}(X)ₘ-A-NH₂ General formula (1′)
wherein X represents —CO— or —SO₂—; A represents an arylene group, or an alkylene group; L represents an alkylene group; R represents an alkyl group, an aryl group, or an acyl group; m is and integer of 0 or 1; and n is an average additional molar number of a polyether group in the range of 10 to 500.

20. A multicolor heat-sensitive recording material according to claim 19, wherein in general formula (1′), A represents an arylene group, and m is an integer of 1.
